(19) United States
(12) Patent Application Publication
(10) Pub. No.: US 2005/0259353 A1
(43) Pub. Date: Nov. 24, 2005

(54) Multi-plane thin-film heads

(75) Inventor: Steven L. Magnusson, Boulder, CO (US)

Correspondence Address: NIXON & VANDERHYE, PC, 901 NORTH GLEBE ROAD, 11TH FLOOR, ARLINGTON, VA, 22203, US

(73) Assignee: Exabyte Corporation, Boulder, CO (US)

(21) Appl. No.: 10/847,655

(22) Filed: May 18, 2004

(51) Int. Cl. G11B 5/147

(52) U.S. Cl. 360/121; 360/126

(57) ABSTRACT

A head unit for use in a helical scan magnetic tape drive comprises a substrate having a substrate surface (300) and multiple thin film magnetic elements (D₁, D₂) formed on the substrate. Each of the multiple thin film magnetic elements has an interactive component for transducing information with respect to magnetic tape. The interactive components of at least two elements are situated on different planes at respective different distances from the substrate surface. None of the multiple elements of the head unit are situated to traverse a same path on the magnetic tape. Moreover, all of the multiple elements of the head unit perform a same type of transducing operation.

### BACKGROUND

1. Field of the Invention

The present invention pertains to magnetic recording, and particularly to apparatus which record/reproduce an alternating-azimuth recorded track pattern on magnetic tape.

2. Related Art and Other Considerations

In magnetic recording on tape using a magnetic tape drive, relative motion between a scanner [typically a drum or rotor with both one or more write element(s) and one or more read element(s)] and the tape causes a plurality of tracks of information to be transduced with respect to the tape. The magnetic tape is typically housed in a cartridge which is loaded into the tape drive. The tape extends between a cartridge supply reel and a cartridge take-up reel. The tape drive typically has a supply reel motor for rotating the cartridge supply reel and a take-up reel motor for rotating the cartridge take-up reel, so that the rotating of the reels causes, e.g., a linear transport or travel of the magnetic tape.

In a helical scan arrangement, the magnetic tape is transported so as to be at least partially wrapped around the scanner during a portion of the path of travel of the tape. Transducing elements (e.g., write elements and read elements) are positioned on the drum to physically record or reproduce data on the tape in a series of discrete stripes oriented at an angle with respect to the direction of tape transport. Typically one or more of the transducing elements are situated on a structure which is often referred to as a module or head or head unit, with the modular structure in turn being mounted on the periphery of the scanner. The data is formatted, prior to recording on the tape, to provide sufficient referencing information to enable later recovery during readout by one or more read transducing elements.

Examples of helical scan apparatus (e.g., helical scan tape drives) are described in the following non-exhaustive and exemplary list of United States patents and United States patent publications: U.S. Pat. No. 5,065,261; U.S. Pat. No. 5,068,757; U.S. Pat. No. 5,142,422; U.S. Pat. No. 5,191,491; U.S. Pat. No. 5,535,068; U.S. Pat. No. 5,602,694; U.S. Pat. No. 5,680,269; U.S. Pat. No. 5,689,382; U.S. Pat. No. 5,726,826; U.S. Pat. No. 5,731,921; U.S. Pat. No. 5,734,518; U.S. Pat. No. 5,953,177; U.S. Pat. No. 5,973,875; U.S. Pat. No. 5,978,165; U.S. Pat. No. 6,144,518; U.S. Pat. No. 6,189,824; U.S. Pat. No. 6,288,864; U.S. Pat. No. 6,697,209; U.S. Patent Publication 2002/0071195; U.S. Patent Publication 2003/0048563; U.S. Patent Publication 2003/0128459; US Patent Publication 2003/023499. The foregoing are all incorporated herein by reference in their entirety, the corresponding US patent applications for the foregoing US patent publications also being incorporated herein.

Multi-channel head structures using thin-film construction techniques have been used extensively in both disk and linear tape head designs, but in helical tape recording devices, individual single-channel heads have typically been fabricated separately, and then mounted close together to form multi-channel structures on the rotating drum. U.S. Pat. Nos. 4,318,146; 4,497,005; and 5,050,024 all show examples of helical head assemblies where single-channel heads (i.e., a head containing only one magnetically active/sensitive element used for either writing or reading) are mounted locally in groups of two or more onto a common “base” to form a quasi-multi-channel head structure.

For linear tape heads, multi-plane arrays of thin-film heads are typically formed by mechanically bonding together multiple substrates which have a (substantially) single plane of write and/or read magnetic elements deposited on the substrate surface. U.S. Pat. Nos. 3,846,841, 4,439,793, 5,027,245, 5,161,299, and 6,038,108 are all examples of this type of construction.

For disk heads, U.S. Pat. No. 4,219,853 shows a monolithic two-plane head structure containing one read element formed first on the surface of the substrate, a thick insulating layer deposited on top of the read element, and one write element formed on top of the insulating layer. The centerlines of the write element and the read element are aligned so they share a common track center.

Prior art helical scan head structures, having separately mounted single channel heads, have considerable mechanical complexity and require precise mechanical tolerances.

### BRIEF SUMMARY

A head unit for use in a helical scan magnetic tape drive comprises a substrate having a substrate surface and multiple thin film magnetic elements formed on the substrate. Each of the multiple thin film magnetic elements has an interactive component for transducing information with respect to magnetic tape. The interactive components of at least two elements are situated on different planes at respective different distances from the substrate surface. None of the multiple elements of the head unit share a common track center (e.g., none of the multiple elements follow a same path when in use). Moreover, all of the multiple elements of the head unit perform a same type of transducing operation.

In an example embodiment, the multiple thin film magnetic elements can be located between the substrate and a cover bar. When the same transducing operation is a write operation, interactive components in the form of front gaps of a write element are utilized. On the other hand, when the same transducing operation is a read operation, interactive components in the form of a MR layer of a read element are utilized.

In differing embodiments, the head unit comprises M*N thin film magnetic elements having their respective M number of interactive components on N number of planes, the N number of planes being a N number of differing distances from the substrate surface, N being an integer greater than one, and M being an integer greater than zero. In one example embodiment, the head unit comprises three thin film magnetic elements, the three thin film magnetic elements having their respective interactive components on three planes, the three planes being at three differing distances from the substrate surface.

Also disclosed are embodiments of scanners. The scanners comprise a rotatable drum having at least two write head units mounted at the periphery of the drum and at least two read head units mounted at the periphery of the drum.

A method of making a head unit for a helical scan tape drive comprises forming a first thin film magnetic element on a substrate, the first thin film element having an interactive component for transducing information with respect to magnetic tape, the interactive component for the first thin film magnetic element being situation on a first plane at a first distance from a surface of the substrate. The method further comprises forming a second thin film magnetic element on a substrate, the second thin film element having an interactive component for transducing information with respect to magnetic tape, the interactive component for the second thin film magnetic element being situation on a second plane at a second distance from a surface of the substrate, the second distance not being equal to the first distance. The method further comprises situating the first thin film magnetic element and the second thin film magnetic element such that they do not share a common track centerline (e.g., they do not follow a same path when in use), and forming the first thin film magnetic element and the second thin film magnetic element to perform a same type of transducing operation.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic top view of an example embodiment of a helical scan transducing system.

FIG. 2 is a schematic view of example components included in the system of FIG. 1.

FIG. 3 is a perspective view of an example embodiment of a first write head chip.

FIG. 3A is an enlarged view of a portion of the first write head chip of FIG. 3.

FIG. 4 is a perspective view of an example embodiment of a second write head chip.

FIG. 4A is an enlarged view of a portion of the second write head chip of FIG. 4.

FIG. 5 is a diagrammatic view showing how a track pattern is written by the first write head chip of FIG. 3 and the second write head chip of FIG. 4.

FIG. 6 is a perspective view of an example embodiment of a first read head chip.

FIG. 6A is an enlarged view of a portion of the first read head chip of FIG. 6.

FIG. 7 is a perspective view of an example embodiment of a second read head chip.

FIG. 7A is an enlarged view of a portion of the second read head chip of FIG. 7

FIG. 8 is a diagrammatic top view showing an example positioning of write head front gaps of write head chips of FIG. 3 and FIG. 4 and read sensors of the read head chips of FIG. 6 and FIG. 7 on a drum.

FIG. 9 is a diagrammatic front view of placement of write head chips of FIG. 3 and FIG. 4 and read head chips of FIG. 6 and FIG. 7 on a drum as seen looking through tape which is transduced by the chips.

FIG. 10 is a diagrammatic view showing how a track pattern is transduced by the write head chips of FIG. 3 and FIG. 4 and by the read head chips of FIG. 6 and FIG. 7.

FIG. 11A and FIG. 11B are enlarged diagrammatic views of example read head chips according to another embodiment.

FIG. 12 is a diagrammatic front view of placement of the write head chips according to FIG. 3 and FIG. 4 and read head chips according to FIG. 11A and FIG. 11B on a drum as seen through tape that is transduced by the chips.

FIG. 13 is a diagrammatic view showing how a track pattern is transduced by the write head chips of FIG. 3 and FIG. 4 and by the read head chips of FIG. 11A and FIG. 11B.

FIG. 14(1) through FIG. 14(4) are diagrammatic views depicting fabrication of plural head units according to an example fabrication process, each head unit being a head chip. FIG. 14(5) shows an example of one head chip being attached to its mounting baseplate structure

FIG. 15(1) through FIG. 15(38) are diagrammatic views depicting fabrication of a head chip according to an example fabrication process

FIG. 16 is a schematic view showing electrical connections and magnetic poles for a two-plane head unit with one magnetic transducing element per plane (non-conducting and non-magentic thin-film structures are shown as transparent).

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail. Moreover, individual function blocks are shown in some of the figures.

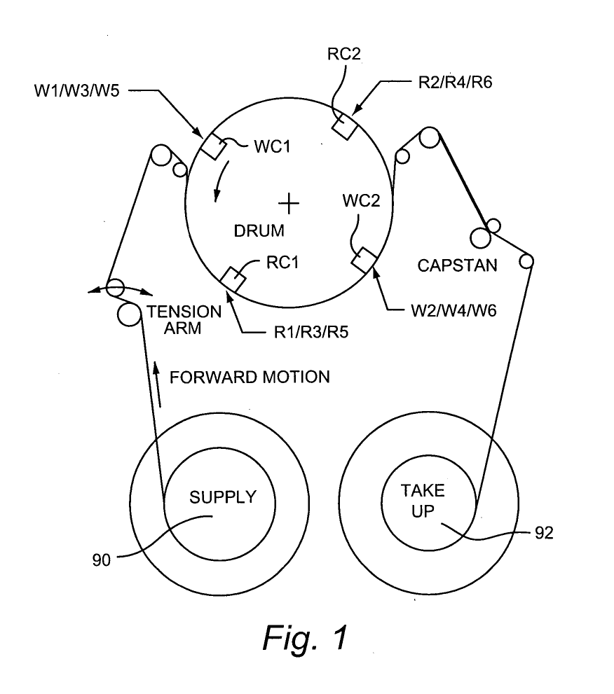

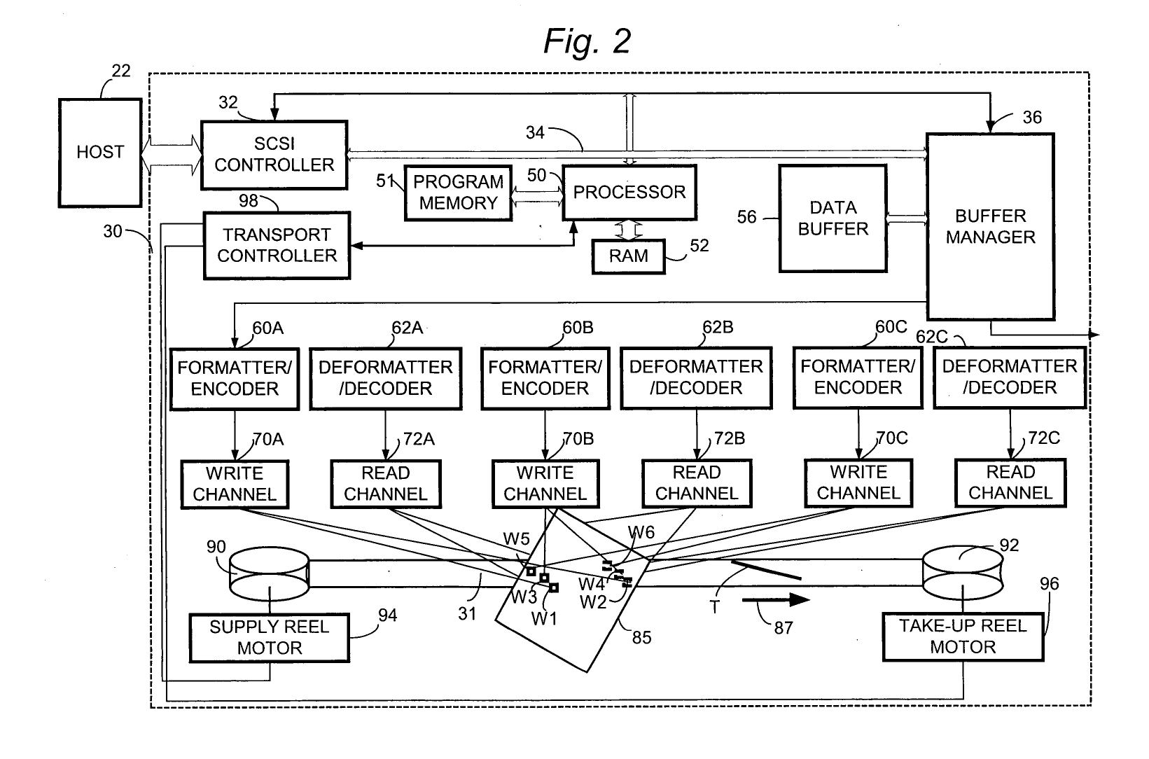

FIG. 1 and FIG. 2 show tape 31 which is physically wrapped (slightly more than 180°, e.g., 190°) around a helical drum or scanner 85 for transducing helical tracks or stripes, one such track T being illustrated in FIG. 2. The length of each written track is slightly less than 180° of drum rotation (e.g., 178°) to allow for efficient sharing of electronics and rotary transformers as typically adopted in helical scan recording (although this is not a requirement of the invention). In the FIG. 1 example embodiment, the rotating portion of the drum 85 has two monolithic write head chips WC1 and WC2 mounted approximately 180° apart, and each write head chip has three independently controlled write front gaps. In particular, write head chip WC1 has write front gaps W1, W3, and W5, while write head chip WC2 has write front gaps W2, W4, and W6. In addition, the rotating portion of the drum has two monolithic read head chips RC1 and RC2 mounted approximately 180° apart, with each read head chip having three independently controlled Magneto-Resistive (MR) sensors. In particular, read head chip RC1 has MR sensors R1, R3, and R5, while read head chip RC2 has MR sensors R2, R4, and R6.

FIG. 2 illustrates an example, non-limiting, representative tape drive in which embodiments of the scanner configurations of the present invention can be deployed. FIG. 2 shows a SCSI bus 20 which connects a host computer 22 and an example embodiment of a target storage device, particularly tape drive 30. In the illustrated embodiment, an example tape drive 30 is shown as a generic helical scan tape drive which transduces information on/from tape 31. Tape drive 30 includes a controller (e.g., SCSI controller) 32 which is connected to bus 20. Data bus 34 connects controller 32 to buffer manager 36. Both SCSI controller 32 and buffer manager 36 are connected by a bus system 40 to processor 50. Processor 50 is also connected to program memory 51 and to a data memory, particularly RAM 52.

Buffer manager 36 controls data flow, e.g., both storage of user data in buffer memory 56 and retrieval of user data from buffer memory 56. User data is data from host 22 for recording on tape 31 or destined from tape 31 to host 22. Buffer manager 36 is also connected to three formatter/encoders 60A, 60B, and 60C and to three deformatter/decoders 62A, 62B, and 62C. The formatter/encoder 60A is connected to a first write channel 70A, while the formatter/encoder 60B is connected to a second write channel 70B, and the formatter/encoder 60C is connected to the third write channel 70C. The deformatter/decoder 62A is connected to a first read channel 72A, while the deformatter/decoder 62B is connected to a second read channel 72B, and the deformatter/decoder 62C is connected to the third read channel 72C.

Inside the drum, the write channel 70A is connected to write heads W 1 and W2; write channel 70B is connected to write heads W3 and W4; write channel 70C is connected to write heads W5 and W6. Similarly, inside the drum the read channel 72A is connected to read heads R1 and R2; read channel 72B is connected to read heads R3 and R4; read channel 72C is connected to read heads R5 and R6. For sake of simplicity, only the write transducing front gaps are illustrated in FIG. 2, it being understood by the person skilled in the art especially with reference to other figures how the read heads are positioned to follow respective the write heads.

Thus, the write elements or write heads W1-W6 and the read elements or read heads R1-R6 are mounted on a peripheral surface of scanner 85, e.g., a rotatable drum or rotor. Tape 31 is wrapped around scanner 85 such that aforementioned heads follow helical stripes T on tape 31 as tape 31 is transported in a direction indicated by arrow 87 from a supply reel 90 to a take-up reel 92. Supply reel 90 and take-up reel 92 are typically housed in an unillustrated cartridge or cassette from which tape 31 is extracted into a tape path that includes wrapping around scanner 85.

In addition to write transducing elements and read transducing elements, scanner 85 can also have certain unillustrated electronics mounted thereon. The scanner-mounted electronics are understood with reference to U.S. patent application Ser. No. 09/761,658, filed Jan. 18, 2001, entitled “PHASE is BASED TIME DOMAIN TRACKING FOR HELICAL SCAN TAPE DRIVE”, and U.S. patent application Ser. No. 09/492,345, filed Jan. 27, 2000, entitled “POWER SUPPLY CIRCUIT AND METHOD OF CALIBRATION THEREFOR”, both of which are incorporated herein by reference in their entirety. Other helical scan systems are disclosed in U.S. patent application Ser. No. 10/441,289, filed May 20, 2003, entitled “Method and Apparatus For Maintaining Consistent Track Pitch In Helical Scan Recorder, and U.S. patent application Ser. No. 10/131,499, filed Apr. 25, 2002, entitled “ALTERNATING-AZIMUTH ANGLE HELICAL TRACK FORMAT USING GROUPED SAME-AZIMUTH ANGLE HEADS”, both of which are incorporated herein by reference in their entirety.

In one embodiment, a supply reel 90 and take-up reel 92 are driven by respective reel motors 94 and 96 to transport tape 31 in the direction 87. Reel motors 94 and 96 are driven by transport controller 98, which ultimately is governed by processor 50. Operation and control of the tape transport mechanism of this type of tape drive including reel motors 94 and 96 is understood by the person skilled in the art with reference, for example, to U.S. Pat. No. 5,680,269 and incorporated herein by reference. Alternatively or additionally, the transport system can include a capstan which imparts motion to the tape 31.

The helical scan system and drums disclosed herein advantageously utilizes new monolithic, multi-plane, multi-element helical head chips. These new head chips are built using thin-film manufacturing techniques and can be used advantageously for recording and reading the track patterns common to helical scan tape drives. Each head chip is a monolith having four characteristics: (1) multiple thin-film magnetic elements or structures are formed on (e.g., built up on) a common planar substrate; (2) for at least two of the magnetic structures formed on the common substrate, the active magnetic components (e.g., the “interactive” components) of the structures that interact with the magnetic tape (i.e., the front gap of an inductive write element or the MR layers of a read element) are on different planes that are at different distances from the planar substrate surface; (3) none of the multiple thin-film magnetic elements within each head share a common track centerline (e.g., none of the multiple elements follow a same path when in use), and (4) all of the multiple thin-film magnetic elements within each monolithic structure are either all for write purposes or all for read purposes (i.e., no monolithic head chip contains both write and read elements). As used herein, “track centerline” should be understood to refer to an existing track which is read by a read element, or to a prospective track which will be written by a write element as the write element traverses its anticipated path.

The following descriptions show/use alternating-azimuth helical track patterns written and read using elements constructed with different azimuth angles of +0° and −0°; however, this is not a requirement and any azimuth angle (even identical azimuth angles) can be used for either head (e.g., +20° and −20°, or +0° and −0°, or +20° and +20°, or +20° and −10°, or +10° and −20°, etc.).

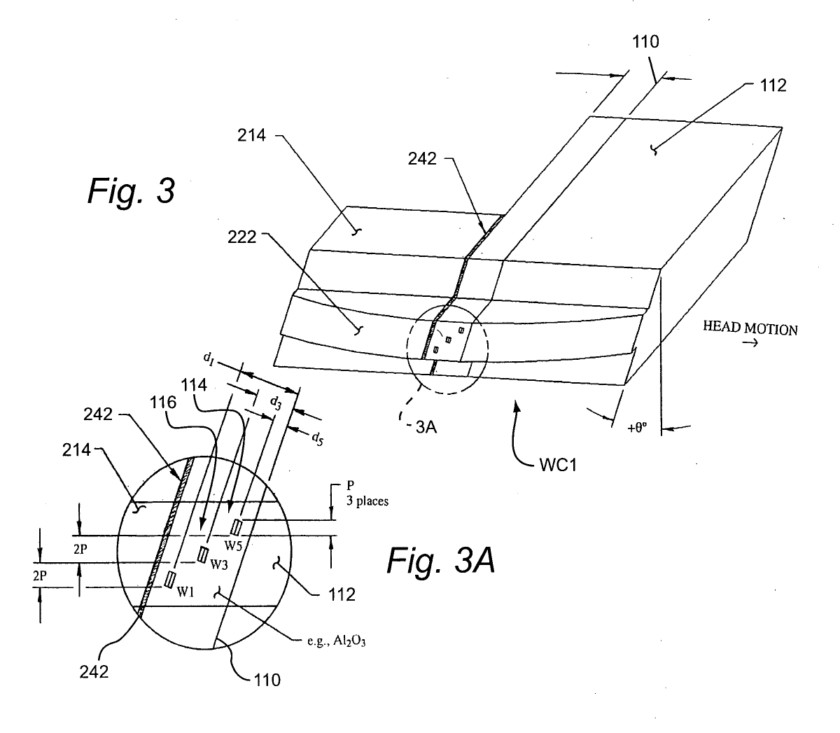

FIG. 3 and FIG. 3A show construction of a W1/W3/W5 write head chip WC1. The W1/W3/W5 write head chip WC1 has three elements W1, W3, and W5, each element having a write gap which is formed and positioned in a manner hereinafter described.

Thin-film processes (additive, subtractive, and/or specialized machining processes—e.g., FIB milling) are used to form all the active magnetic components described herein. In the thin film process for forming head chip WC1, for example, the (inductive) W5 element is formed first so the plane of the W5 front gap (from which the magnetic field emanates for writing) is closest to a plane 110 of substrate 112 of write chip WC1. A thick protective overcoat 114 (e.g., Al₂O₃) is deposited over the W5 thin-film structure and re-planarized so that the W3 element can be formed on this new plane which puts the W3 front gap farther from substrate plane 110 than the W5 front gap (i.e., d₃>d₅). Similarly, a thick protective overcoat 116 is deposited over the W3 thin-film structure and re-planarized so that the W1 element can be formed on this new plane which puts the W1 front gap farther from the substrate plane 110 than the W3 front gap (i.e., d₁>d₃>d₅). Advantageously, the physical spatial relationships between the W1, W3, and W5 front gaps within the finished head chip are controlled by the more accurate thin-film process rather than the mechanical mounting and adjusting of independent mechanical structures per the prior art.

The vertical distance (measured perpendicular to the direction of head motion) between each write front gap is nominally 2P (where P is the trackpitch of the desired on-tape track pattern), and the effective magnetic width of each write front gap (measured perpendicular to the head motion) is 1P. The direction of head motion of is labeled as “HEAD MOTION” in FIG. 3 and is parallel to the bottom surface of the head chip.

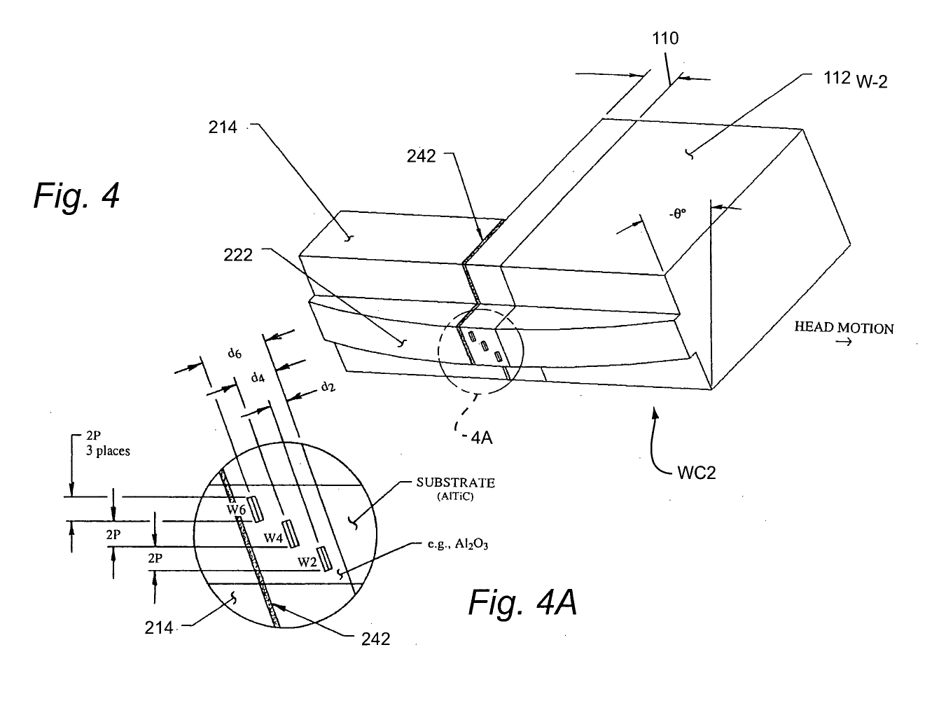

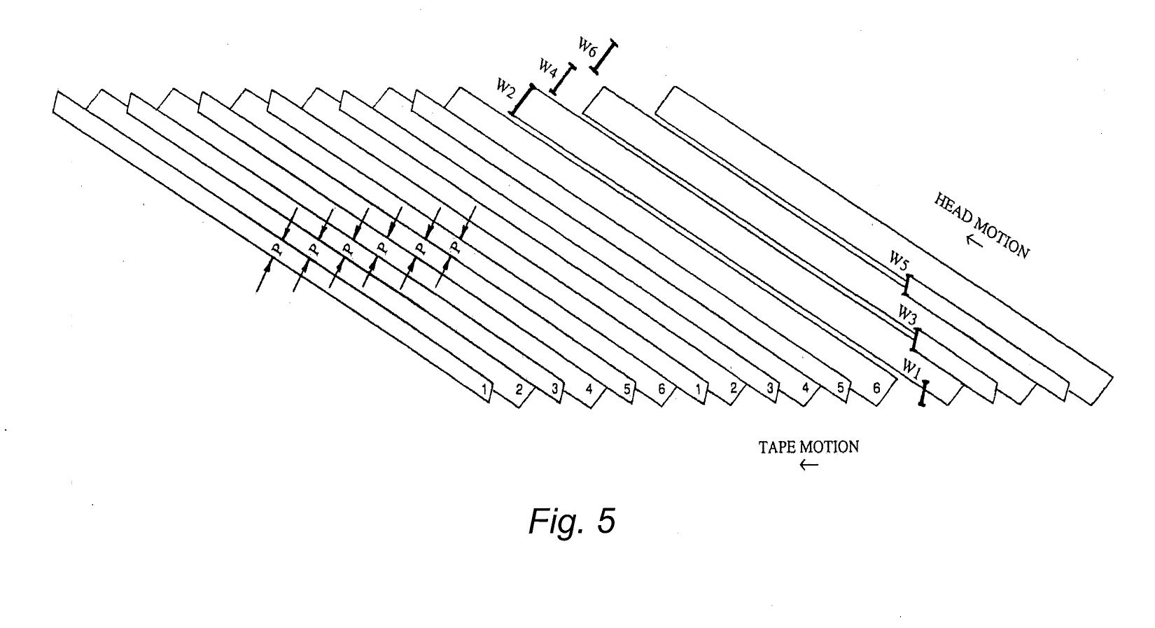

FIG. 4 and FIG. 4A show the construction of the W2/W4/W6 write head chip WC2, which is similar to the construction of the W1/W3/W5 write head chip, except that the effective magnetic width of each write front gap (measured perpendicular to the head motion) is in the range of 1.5P to 2.5P and is preferably about 2P (and, of course, it is made at a different azimuth angle if desired). Again, each front write gap is a different distance from the substrate plane 110 (i.e., d₆>d₄>d₂).

The relative vertical relationship between the two write head chips WC1 and WC2 on the drum 85 is set so that a group of six spatially adjacent tracks is written onto the tape surface during each drum revolution as shown pictorially in FIG. 5. The W1 front gap writes each Track 1, the W2 front gap writes each Track 2, the W3 front gap writes each Track 3, and so on. The W2/W4/W6 head chip WC2 first writes three wide tracks onto the tape which are then subsequently overlapped by the pattern of the three narrow tracks written by the W1/W3/W5 head chip WC1 which results a group of six adjacent tracks of nominally equal trackpitch P on the tape surface for each drum revolution. The linear tape speed is selected in conjunction with the drum diameter, the drum RPM, and the drum helix angle such that for each drum revolution the forward tape motion accommodates a distance corresponding to six tracks.

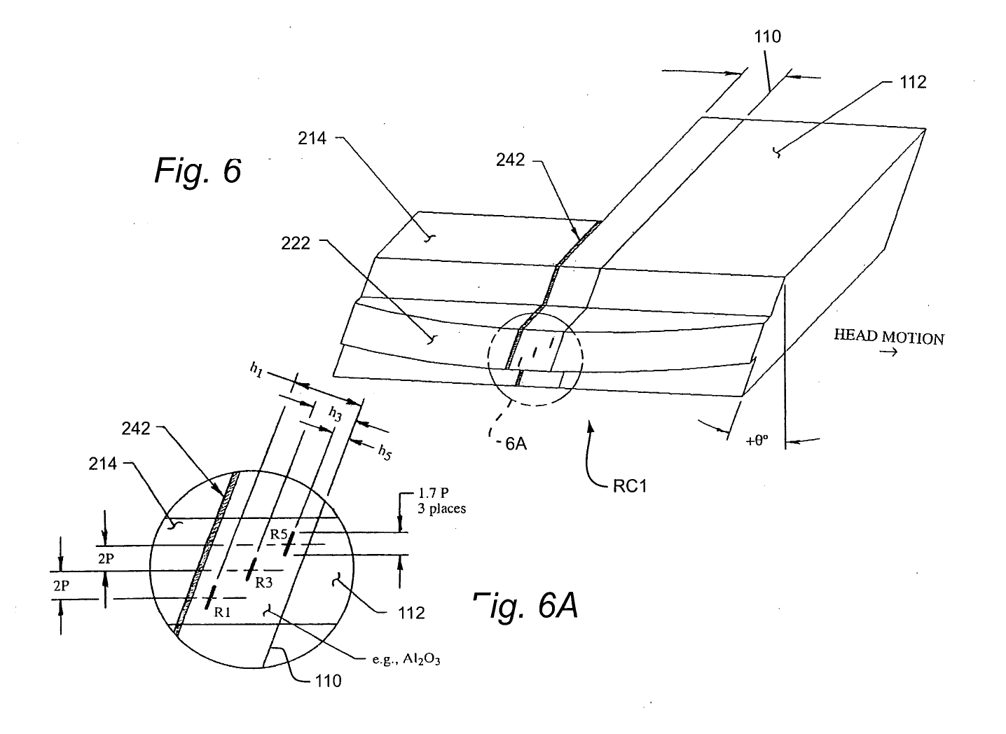

The MR read heads are also configured in a similar manner. The two monolithic read head chips RC1 and RC2 are mounted approximately 180° apart. Each read head chip RC1 and RC2 has three independent MR read sensors as shown in FIG. 1. FIG. 6 and FIG. 6A show the construction of the R1/R3/R5 read head chip (for a Write-Narrow-Read-Wide approach).

Again, the three MR read sensors (R1, R3, and R5) are formed on different planes that are different distances from the substrate plane 110 of substrate 112 (i.e., h₁>h₃>h₅). The vertical distance (measured perpendicular to the head motion) between each MR read element is nominally 2P, and the effective width of each MR read element (measured perpendicular to the head motion) is typically in the range of 1.5P to 1.9P when using the WNRW approach with a preferred nominal value of ˜1.7P. For the Write-Wide-Read-Narrow approach, the effective width of each MR read element could be reduced to be <1P (e.g. 0.3P).

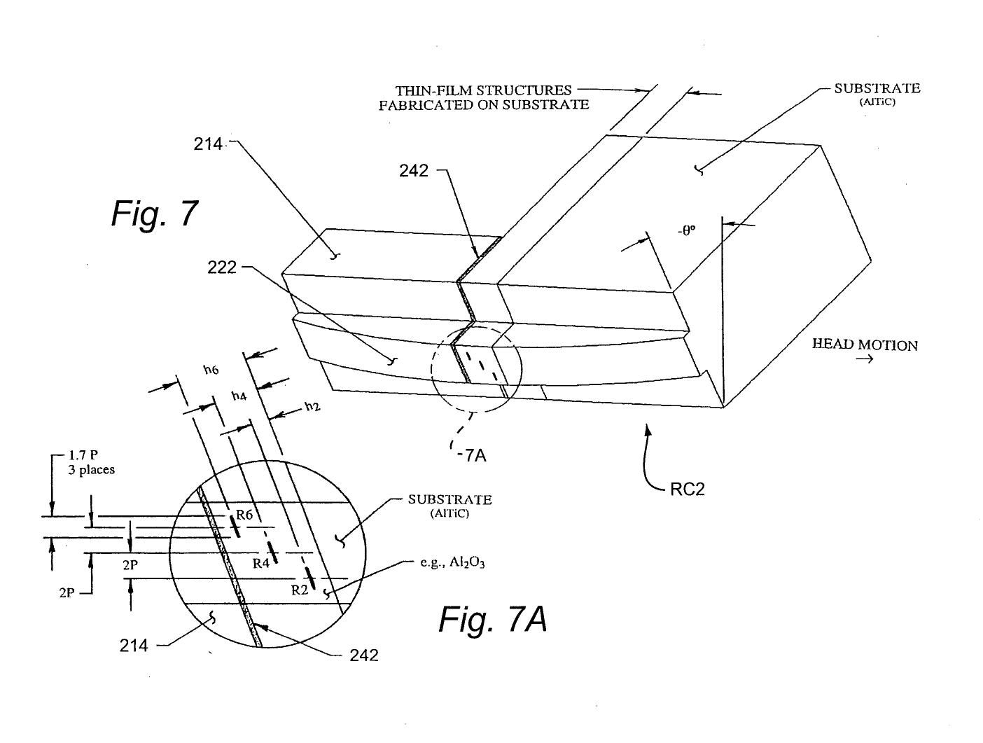

FIG. 7 and FIG. 7A show the construction of the corresponding R2/R4/R6 read head chip RC2 (again for the WNRW approach).

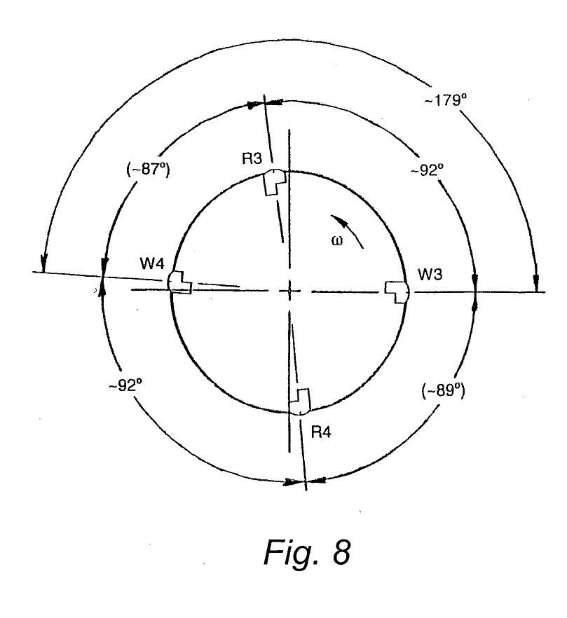

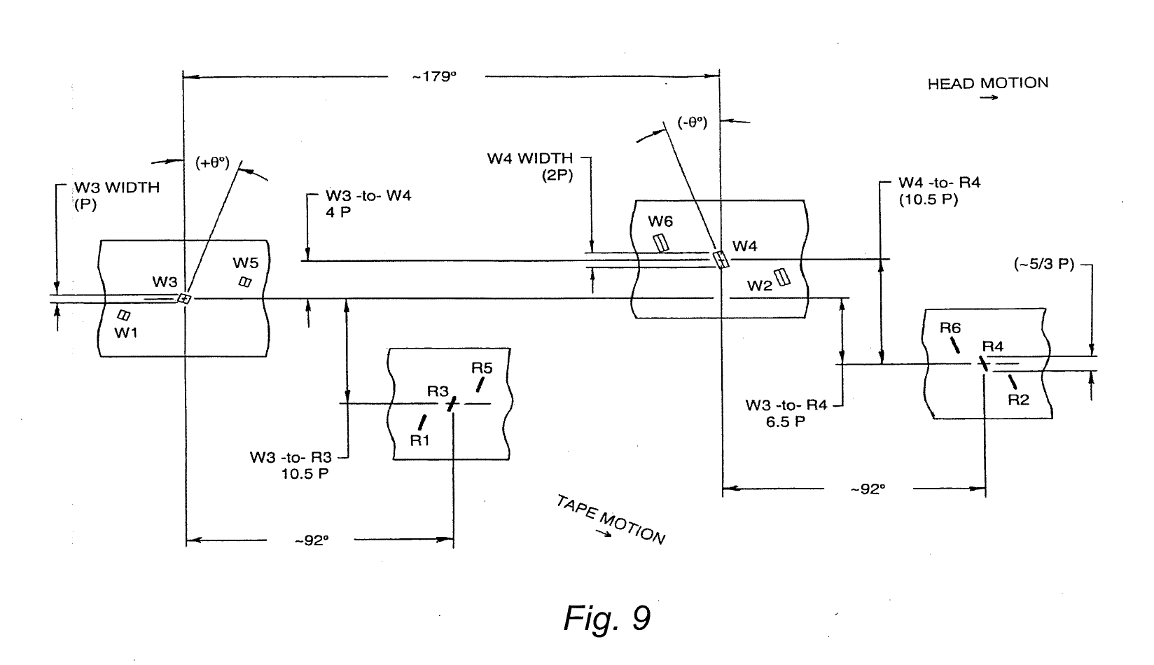

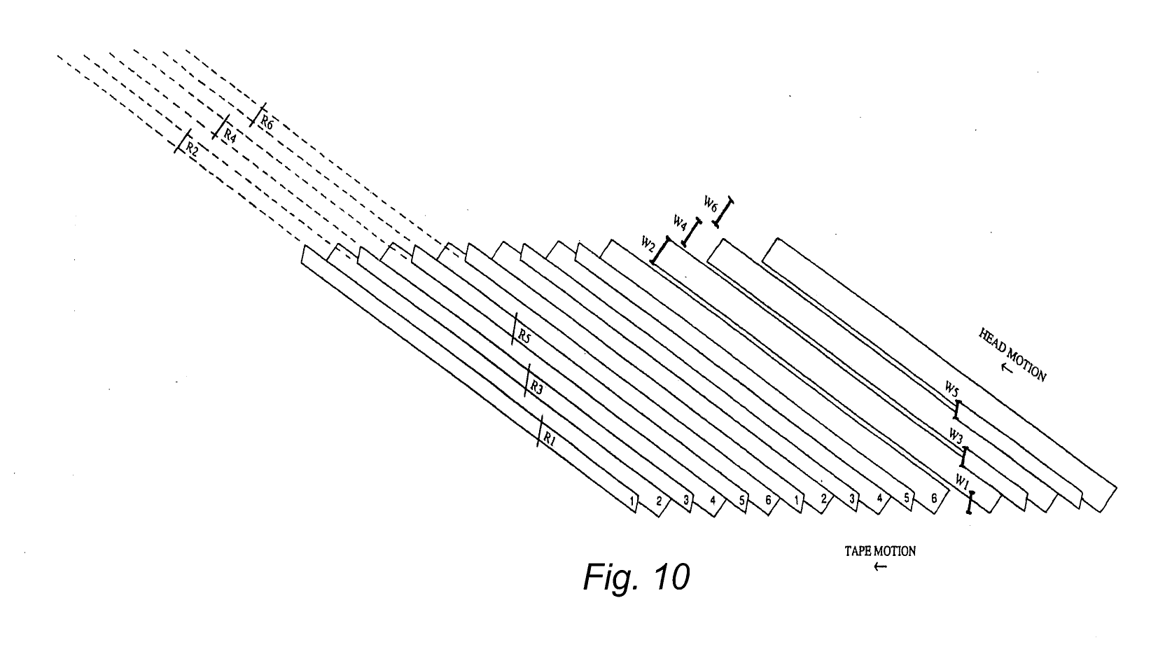

The vertical positions of the MR read head sensors relative to the write head front gaps on the rotating portion of the drum are typically selected so that the MR read head sensors “follow slightly behind” the write head front gaps so that the data just previously written by the write head front gaps can be subsequently recovered and checked during the writing process (a.k.a., “read after write”, “read while write”, or “check after write”). FIG. 8 and FIG. 9 illustrate one possible set of the relative positions of the write head front gaps and the MR read sensors on the drum 85. FIG. 10 shows the resulting relative positions of the write head front gaps and the MR read head sensors on the tape surface during the “read while write” process.

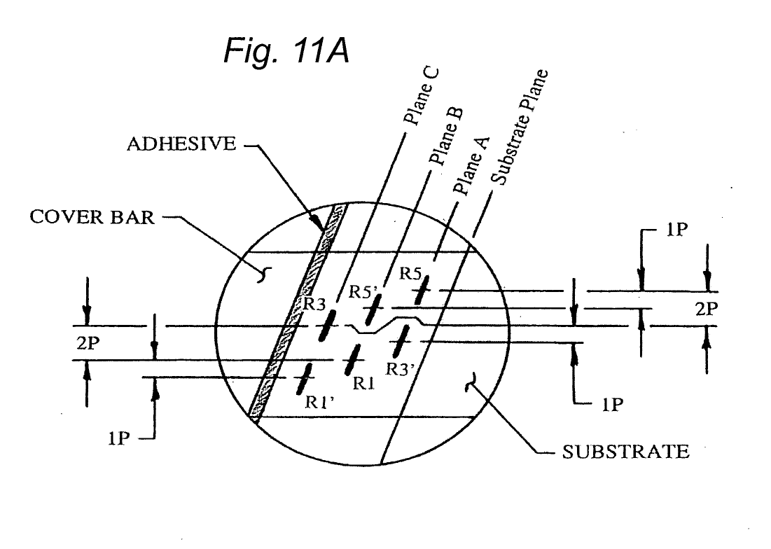

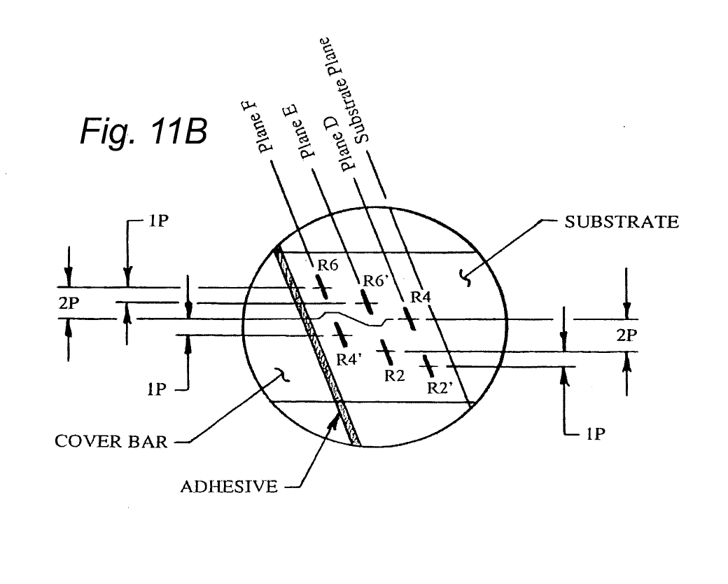

U.S. Pat. No. 6,246,551 discloses a method where, during the reading of a pre-recorded helical tape with an alternating-azimuth track pattern, a pair of like-azimuth read heads are used for reading each helical track (a.k.a., “overscanning”) rather than a single like-azimuth read head for each track. The present invention is also well-suited to this method as the read elements (R1, R2, R3, R4, R5, and R6) can be rearranged and the additional read elements (R1′, R2′, R3′, R4′, R5′, and R6′) can be added to the 3-plane structures as shown in FIG. 11A and FIG. 11B with the additional read elements (referenced by prime numbers) offset by the vertical distance P from their corresponding partner (i.e., R1′ is 1P below R1, R2′ is 1P below R2, etc.).

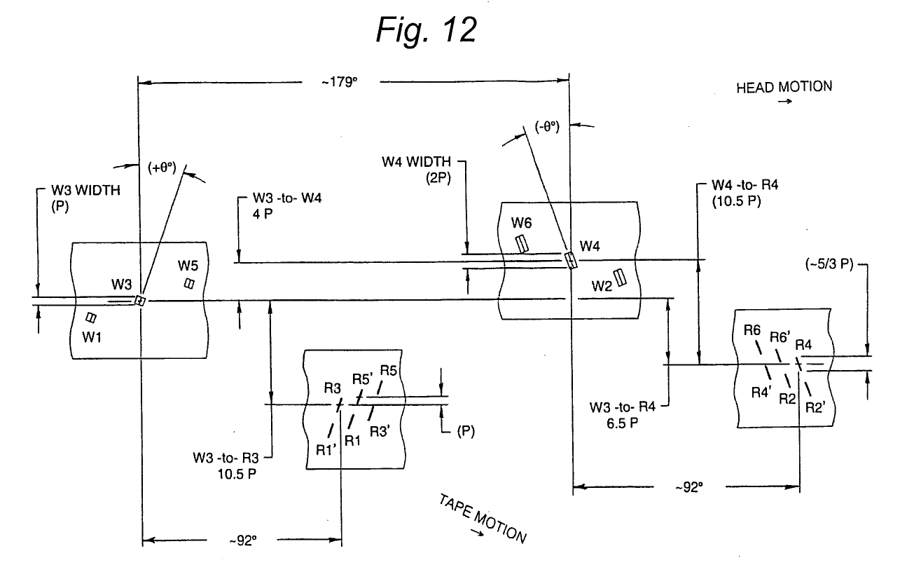

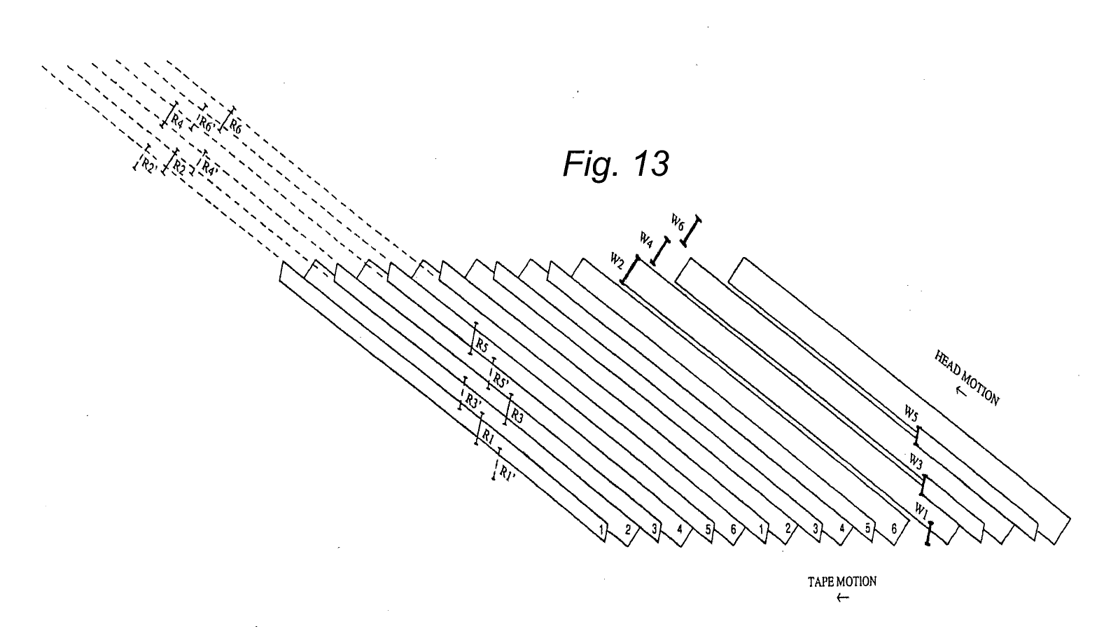

FIG. 12 shows one possible set of the relative positions for the write and read heads on the drum and FIG. 13 their resulting relative positions on the tape surface during the “read while write” process for the alternate embodiment of FIG. 11A and FIG. 11B.

The configurations and techniques taught herein are extendable to any head design that has multiple write front gaps and/or multiple read sensors. As a general rule, the head unit comprises M*N thin film magnetic elements having their respective interactive M number of components per plane on N number of planes, the N number of planes being a N number of differing distances from the substrate surface, N being an integer greater than one, M being an integer greater than zero.

Thus, although the preferred embodiment describes a helical drum with six total write gaps split into two head chips with three write gaps each where each head chip has three-planes and each plane has one write gap, this same multi-plane approach can be applied to other head designs and in different ways. A first example is a system, drum, or write head chip having four total write front gaps which are split into two head chips with two write front gaps each where each head chip has two planes and each plane has one write front gap. A second example is a system drum, or write head chip having eight total write front gaps which are split into two head chips with four write front gaps each where each head chip has four planes and each plane has one write front gap. A third example is a system drum, or write head chip having eight total write front gaps which are split into two head chips with four write front gaps each, with each head chip having two planes and each plane has two write front gaps.

The same flexibility (with N number of planes and M of elements per plane) applies to splitting up the read sensors as long as the four primary characteristics listed previously are met.

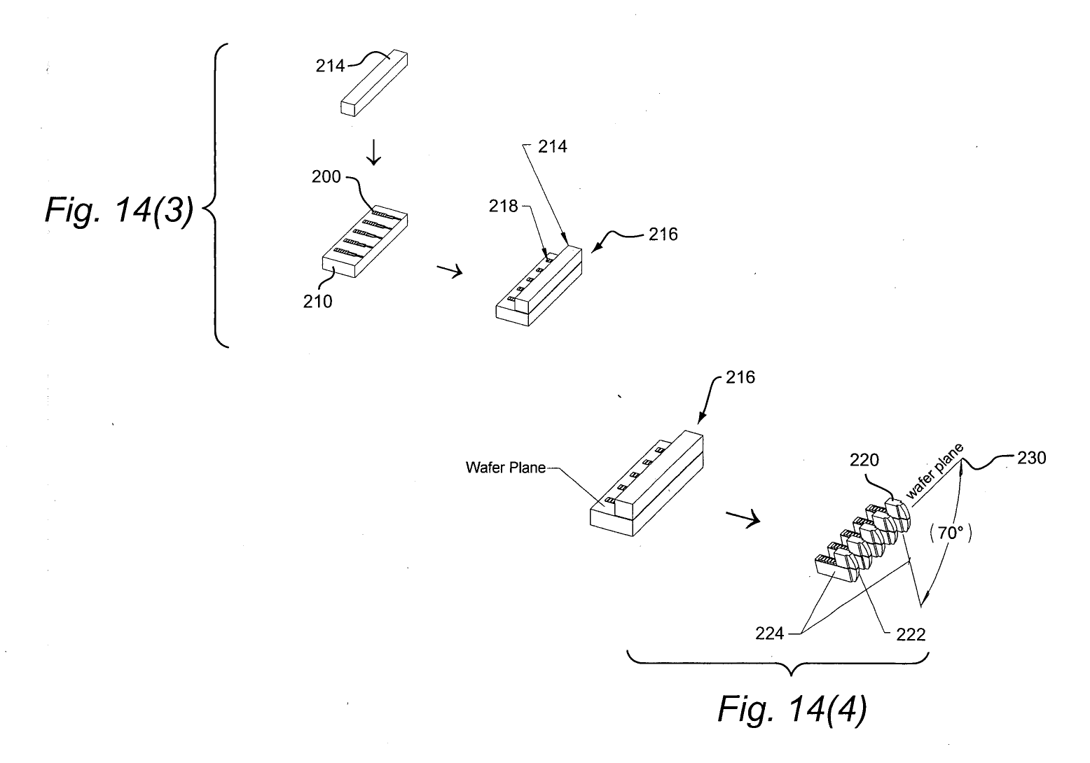

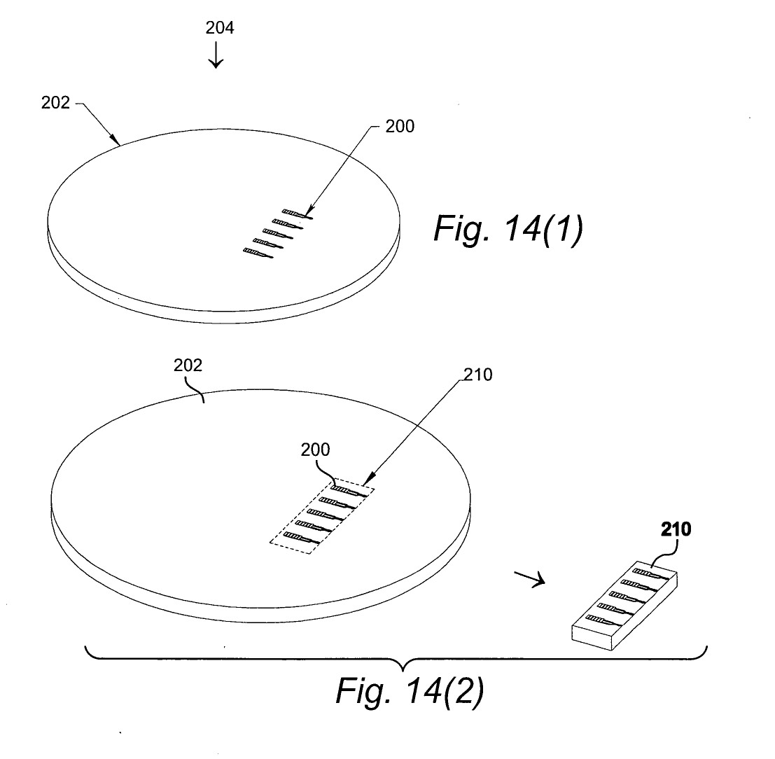

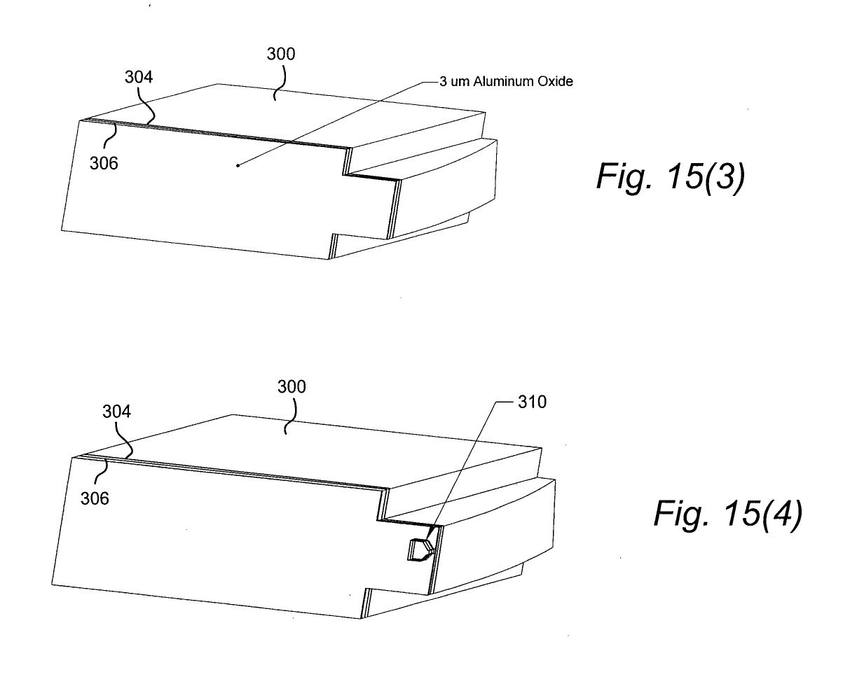

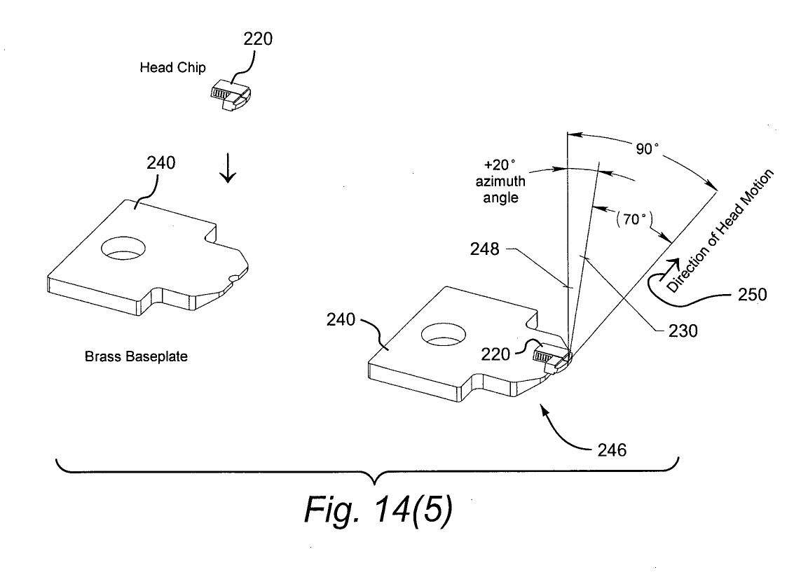

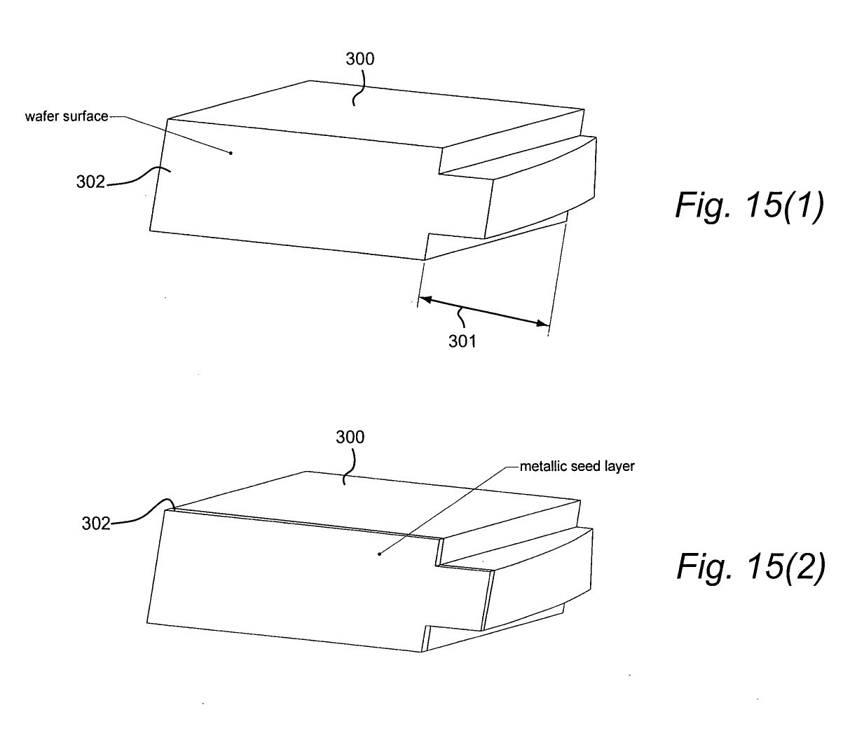

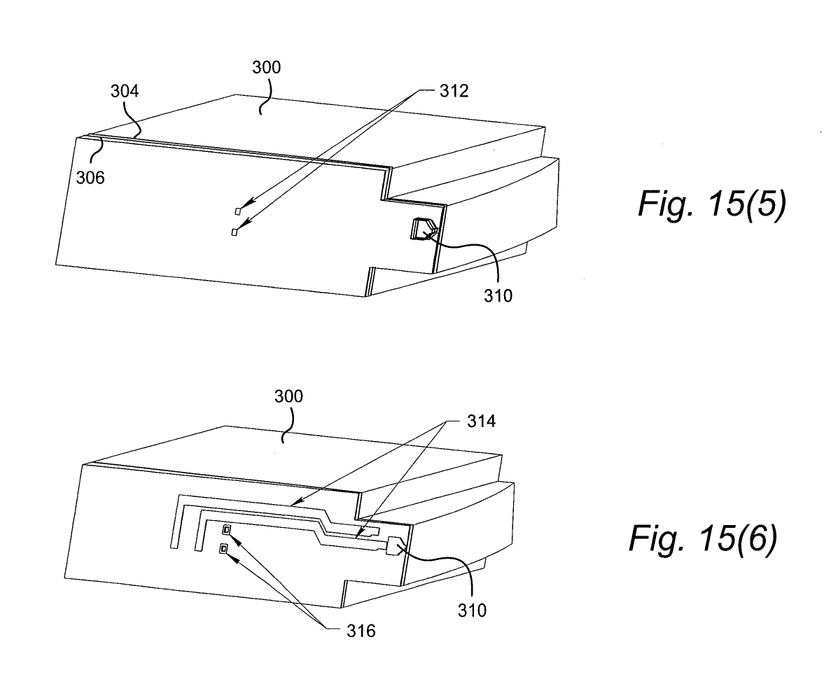

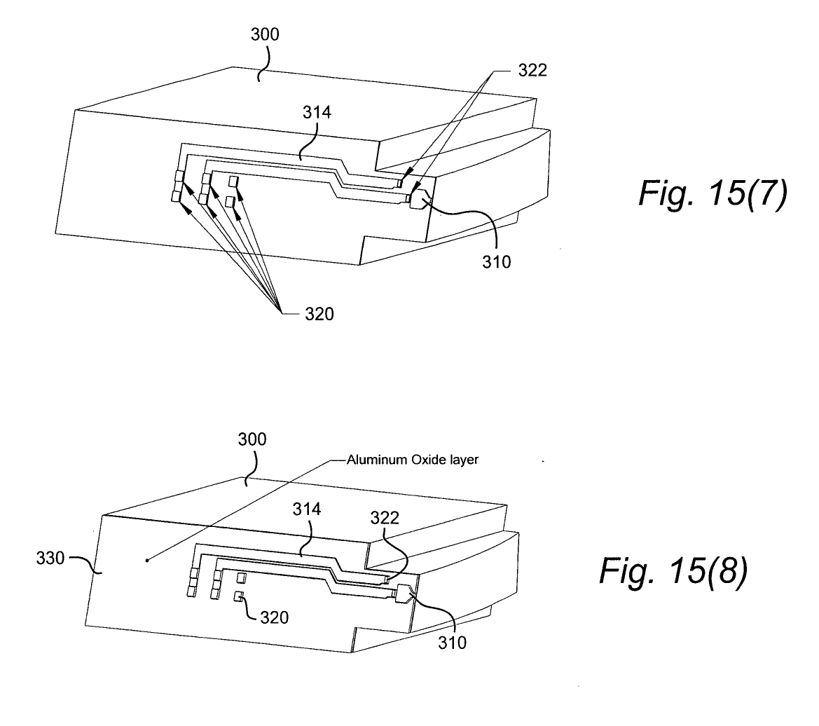

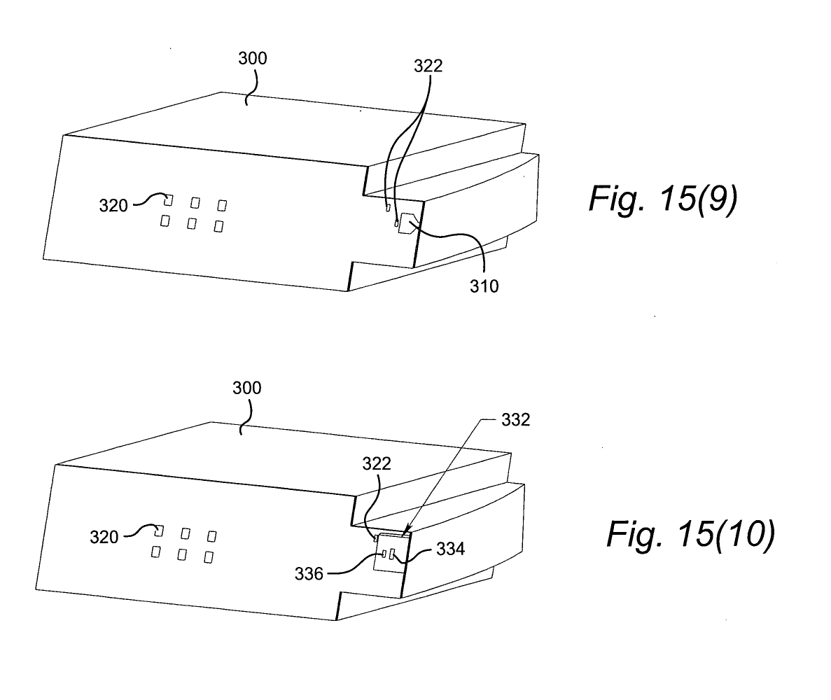

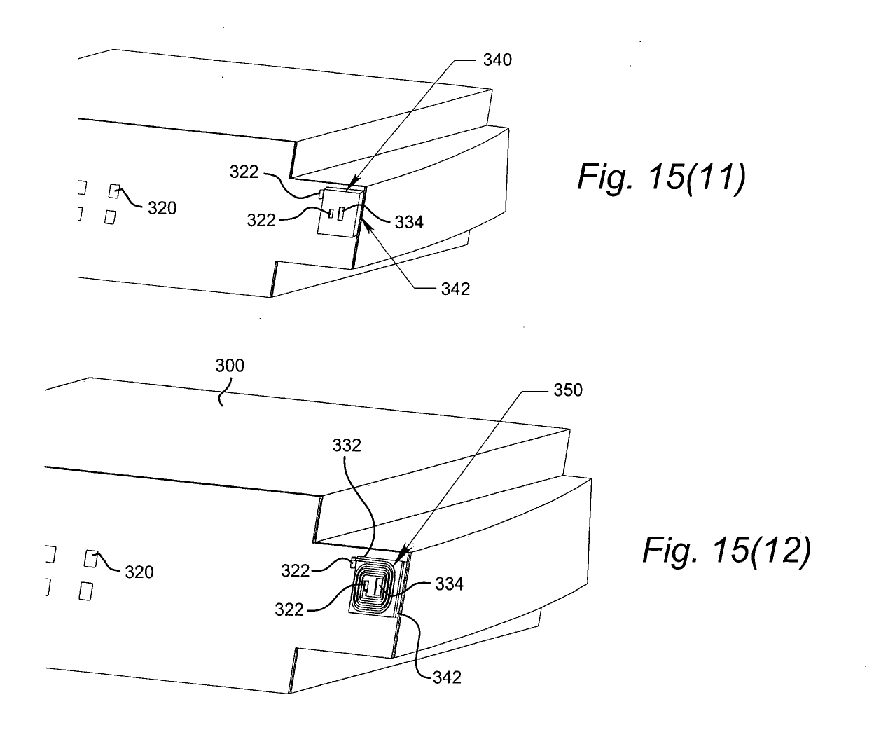

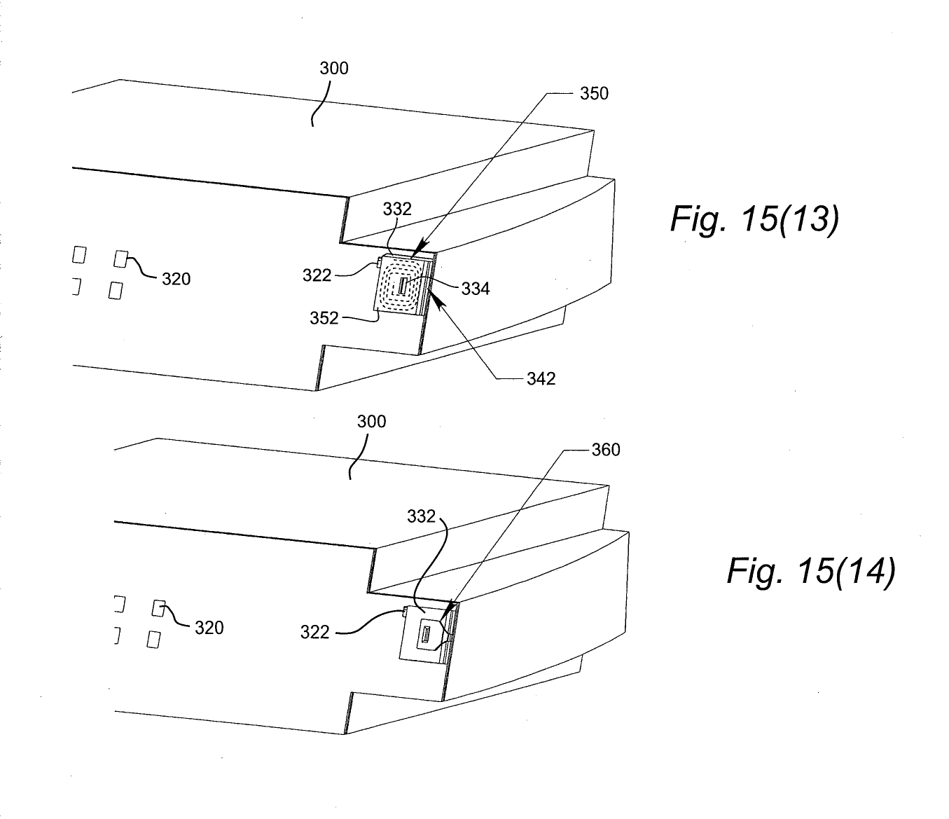

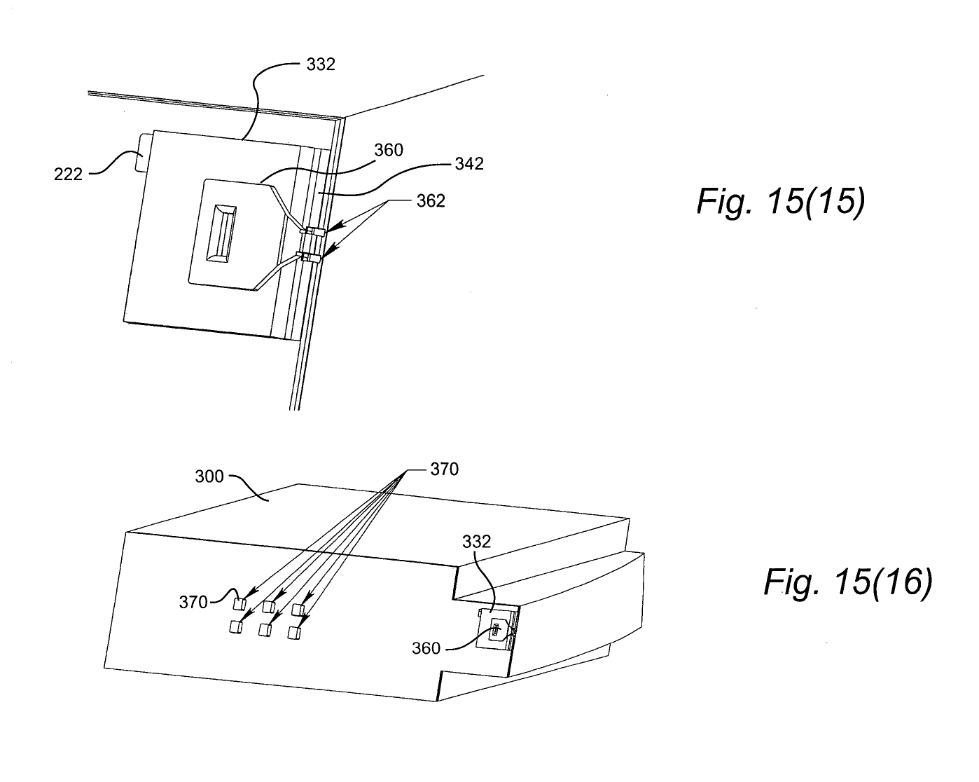

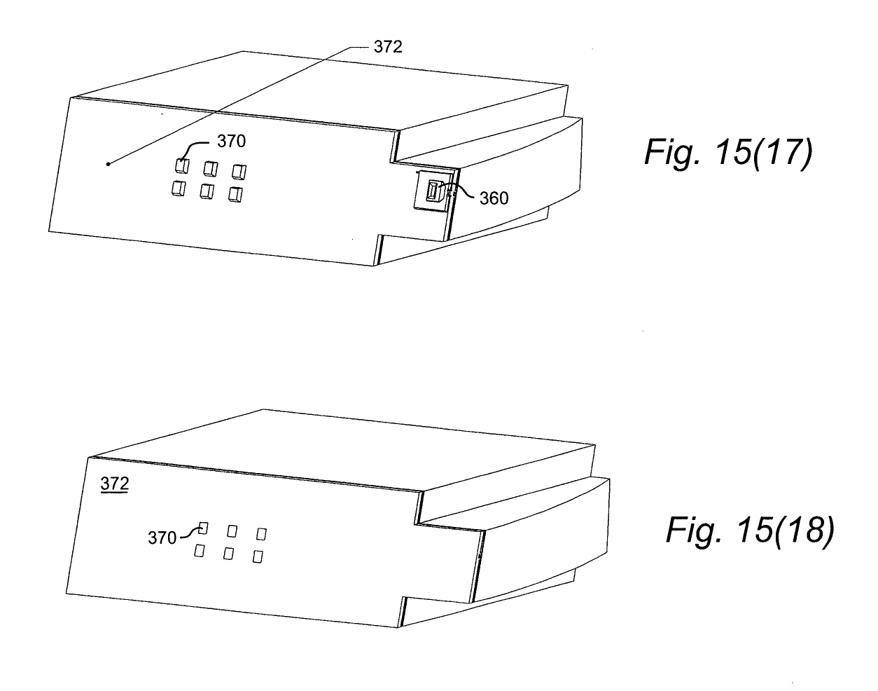

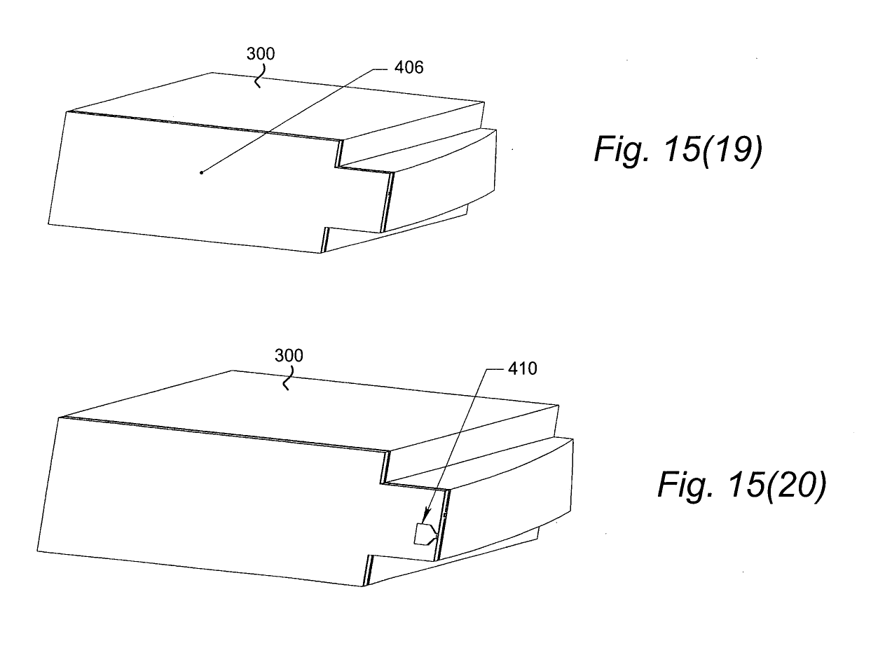

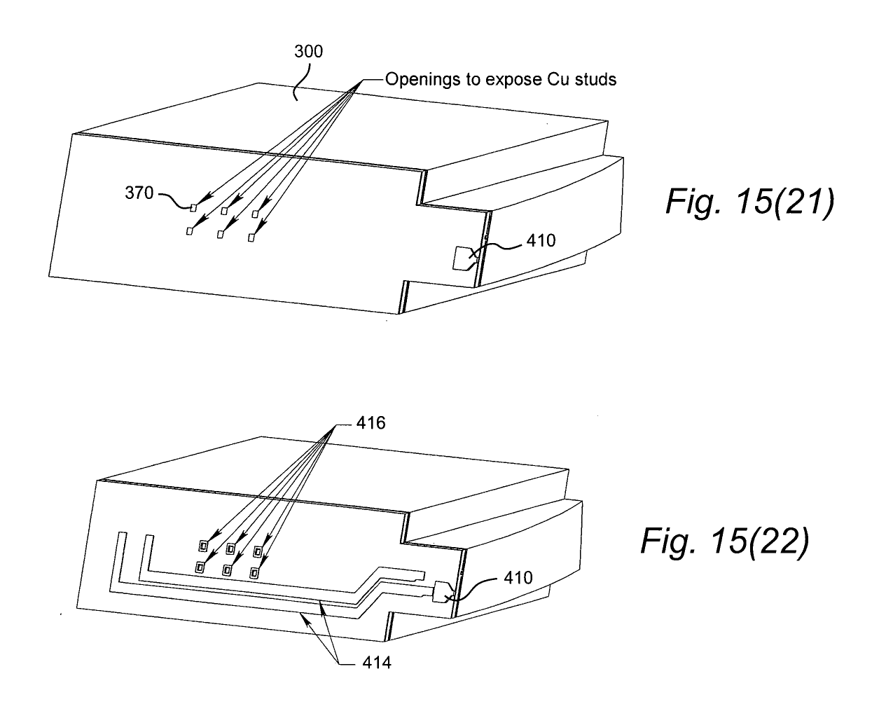

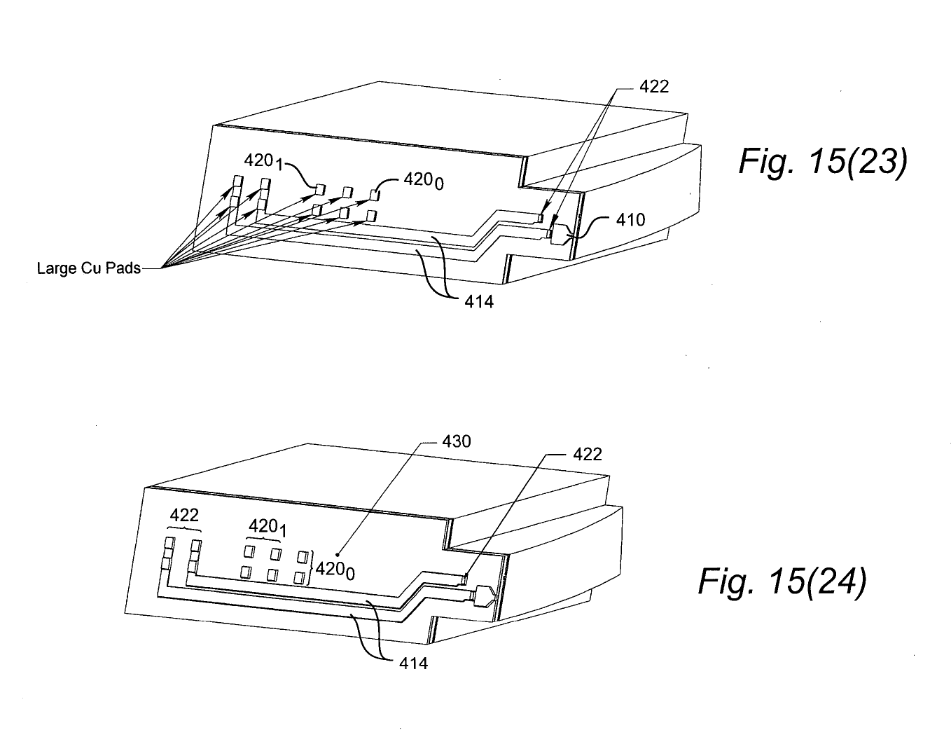

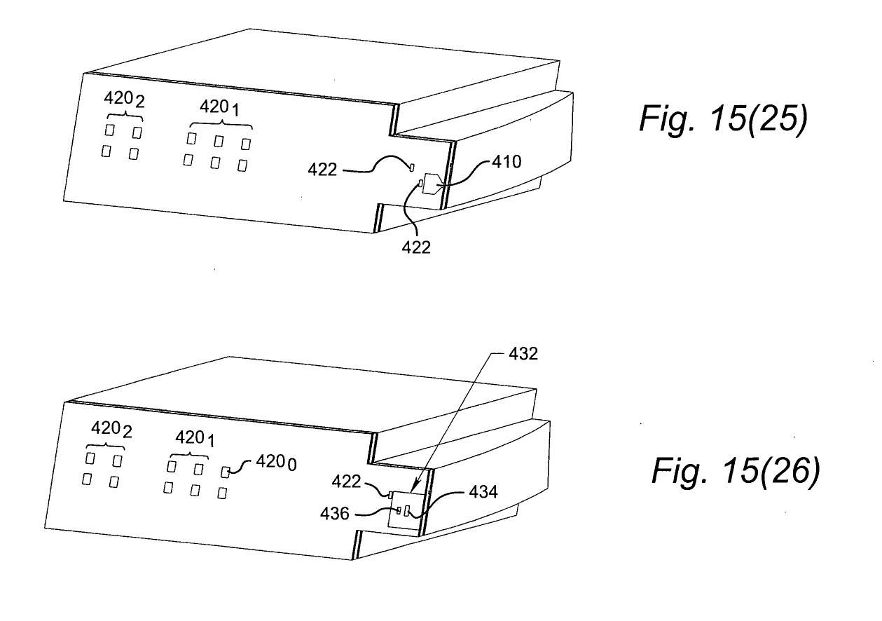

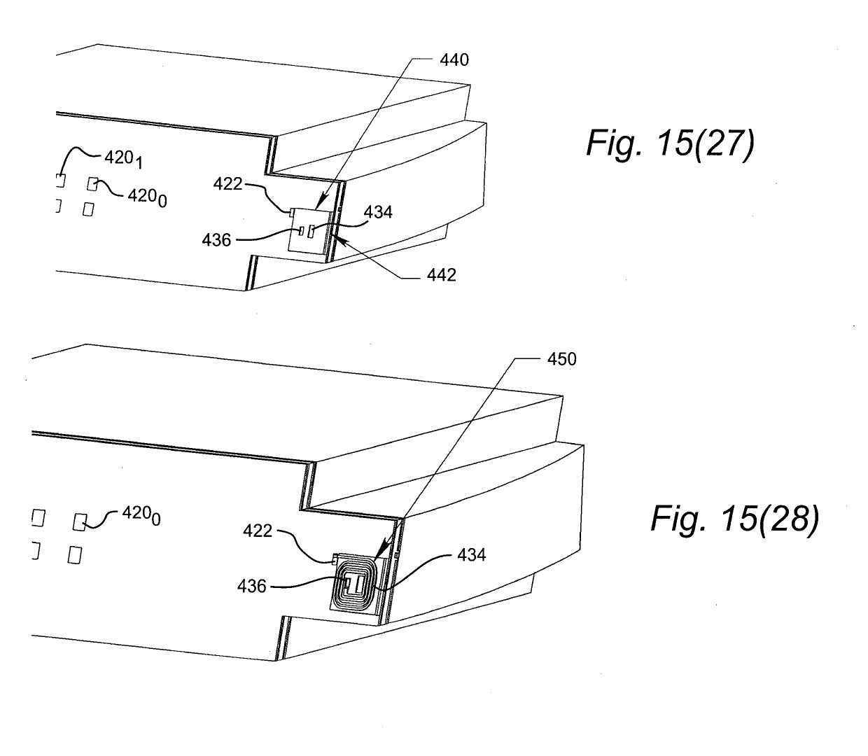

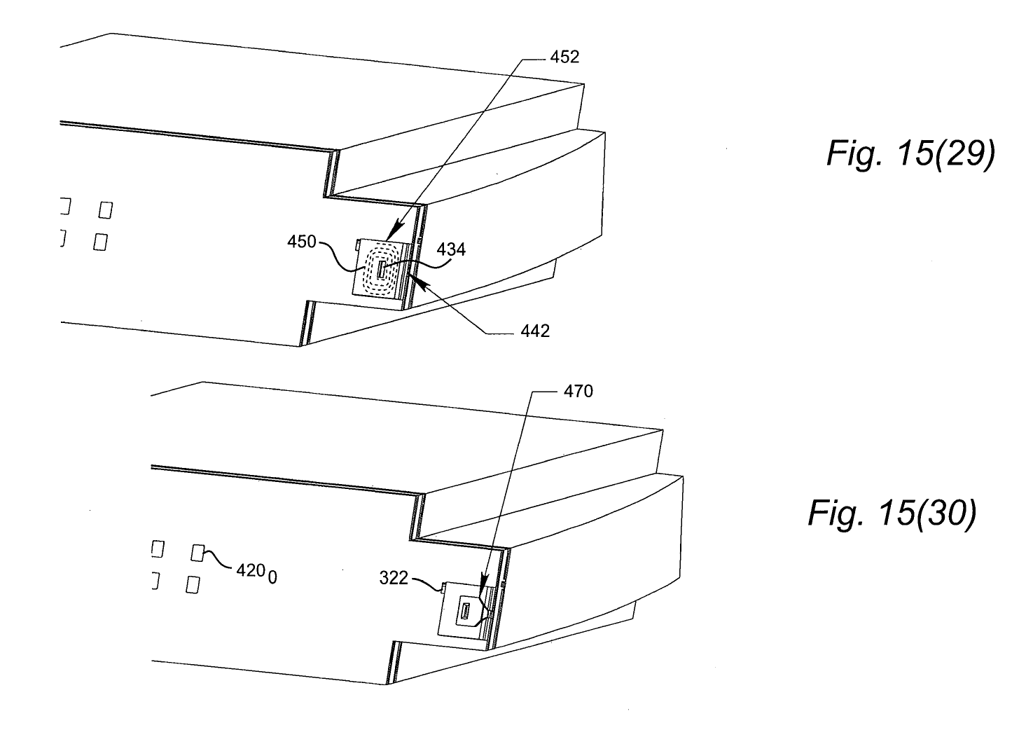

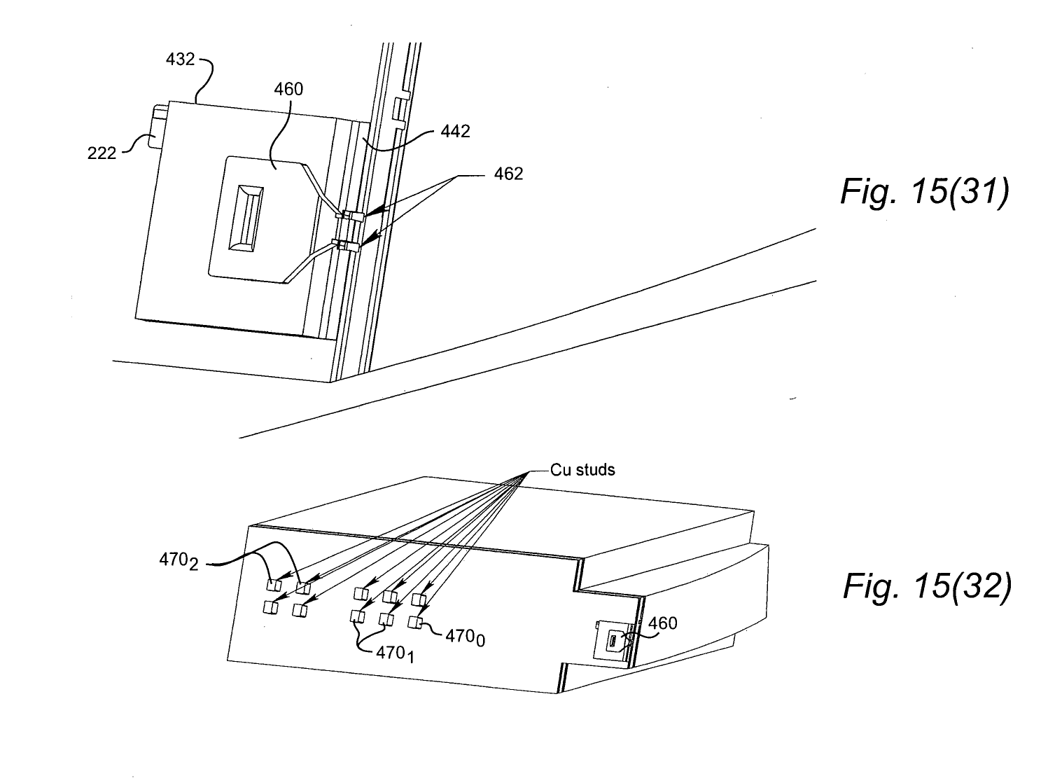

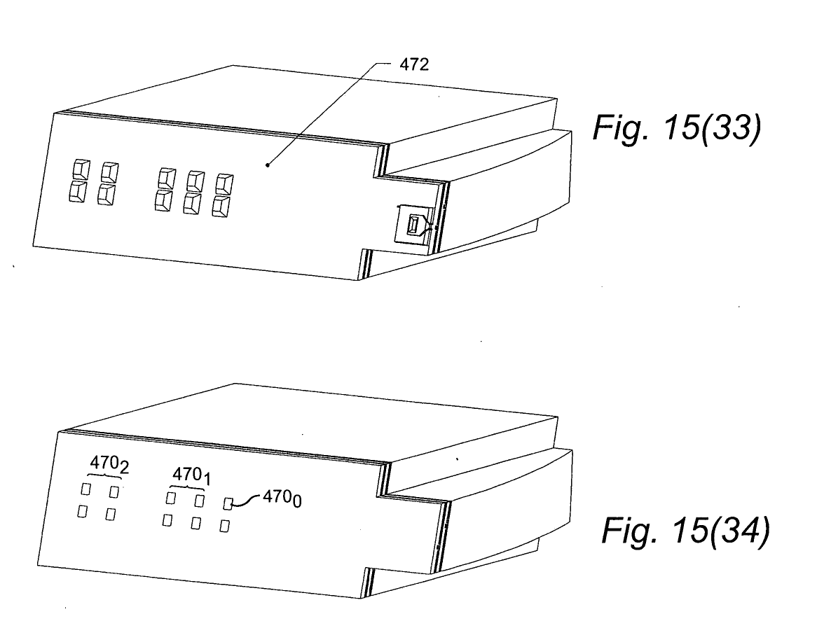

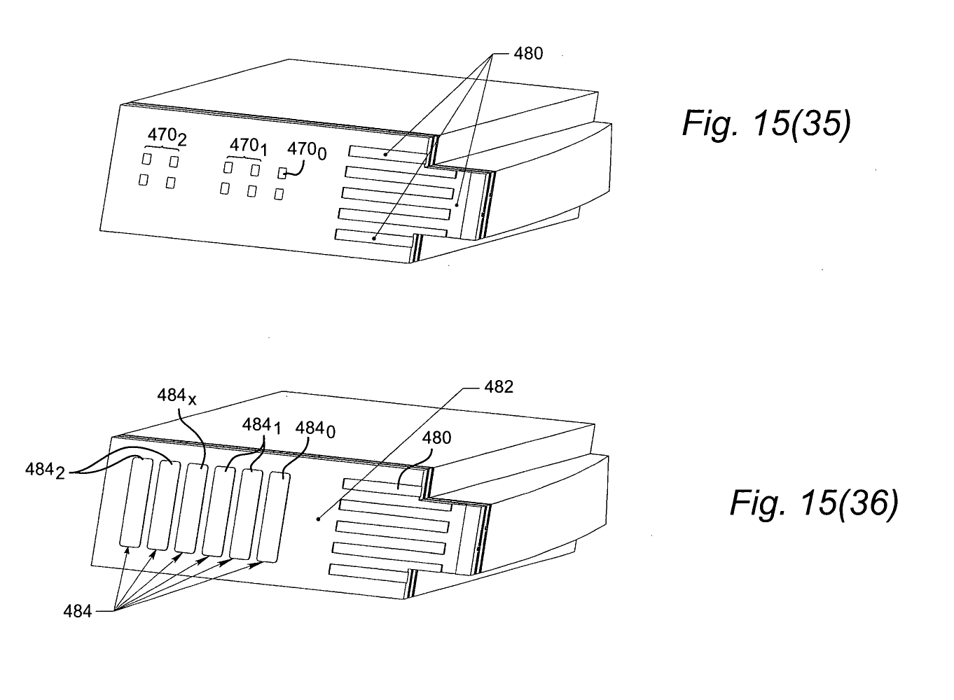

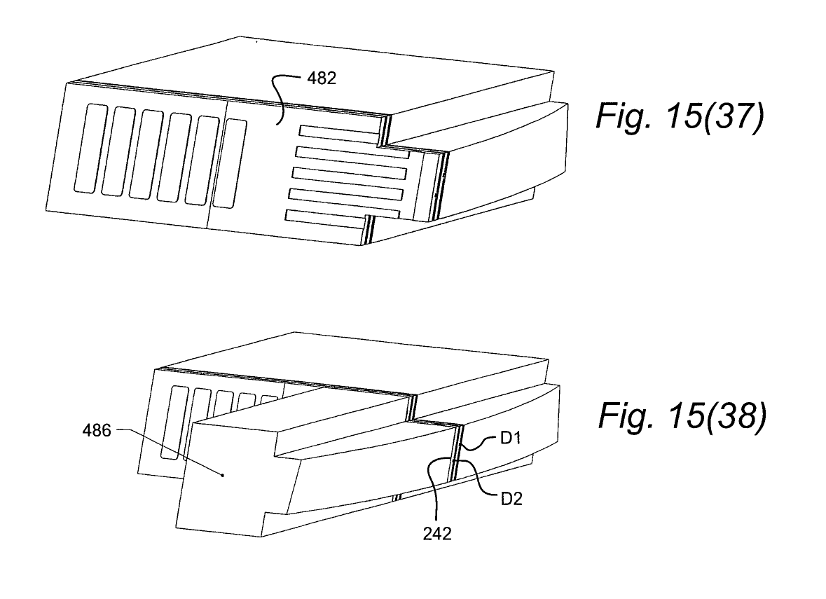

FIG. 14(1) through FIG. 14(5) illustrate example basic steps in the fabrication of a head unit which incorporates a head chip such as any of the write head chips or read head chips previously described or otherwise within the spirit hereof. It will therefore be appreciated that these steps apply essentially similarly to fabrication of either write head units or read head units. The steps of FIG. 14(1) through FIG. 14(4) show how plural write head chips can be formed essentially simultaneously starting from one wafer. FIG. 14(5) shows one head chip mounted to its baseplate structure, forming a head unit, which is subsequently mounted to the rotating drum. An example method of actual formation of the head chips themselves for a given head unit is subsequently described in more detail with reference to the fabrication process of FIG. 15(1) through FIG. 15(38).

As step 14-1, illustrated in FIG. 14(1), plural thin film structures 200 are deposited/formed/shaped on a wafer (AlTiC) surface, e.g., wafer plane 202. Arrow 204 in FIG. 14(1) depicts the general film deposition/shaping direction (which is perpendicular to the wafer surface 202 on the top plane of the wafer). The multi film structures 200 are deposited/shaped on the wafer surface 202 in linear arrays. Only one array is shown in FIG. 14(1) for sake of simplicity, FIG. 14(1) showing only magnetic and conductive film structures.

As step 14-2, illustrated in FIG. 14(2), the wafer is cut into wafer bars 210. As step 14-3, illustrated in FIG. 14(3), a cover bar 214 (made of the same AlTiC material as the wafer) is bonded (e.g., by an adhesive) to the wafer bar 210 to form a bonded bar 216. The cover bar 214 has a shorter depth than the wafer bar 210 so that electrical contacts 218 on the wafer surface are still exposed for later connection to a printed-wire flex circuit. The electrical contacts 218 either eventually attach to the inductive write coils or the MR read elements.

As step 14-4, illustrated in FIG. 14(4), the bonded bar 216 is machined/formed into individual head chips 220. In particular, as an example, step 14-4 can involve machining, grinding, and/or polishing operations to form the bidirectionally curved tape contacting surfaces 222 of the head chips 220 and the chip mounting surfaces 224. The linear array is separated into individual film structure devices head chips 220. Step 14-4 is performed so that an angle between wafer plane, e.g., wafer surface 202, and chip mounting surface 224 gives the desired azimuth angle when the chip is mounted to the drum 85. For the general case, the angle between the wafer plane 202 and surface 224 is equal to 90 degrees minus the desired azimuth angle θ, for which reason FIG. 14(4) is drawn to show a desired θ of +20 deg—i.e., 90 degrees minus +20 degrees=70 degrees.

As step 14-5, illustrated in FIG. 14(5), the head chip 220 is mounted to a brass baseplate 240, e.g., by adhesive to form a head chip/baseplate assembly 246. The brass baseplate 240 is, in turn, mounted to the rotating portion of the helical scanner (e.g., drum 85) such that the tape contacting surface of the head chip 222 is brought into contact with the tape. In FIG. 14(5), line 248 depicts a direction perpendicular to the head motion. Line 250 depicts the direction of head motion. FIG. 14(5) also specifically shows the head chip having an azimuth angle of +20 degrees.

FIG. 15(1) through FIG. 15(38) show example basic steps in the fabrication of the thin film structures 200 which serve as the functional structures (either inductive write or MR read) of the head chips. In other words, FIG. 15(1) through FIG. 15(38) describe an example way of forming the thin film elements 200 utilized at the beginning of the fabrication technique of FIG. 14(1) through FIG. 14(5). For sake of illustration, FIG. 15(1) through FIG. 15(38) show head chip fabrication as if the maching/grinding/polishing operations of FIG. 14(4) had already been performed. Such need not be the case, but is so illustrated for aiding the reader in visualizing the ultimate environment of and utilization of the head chip.

For sake of simplification, formation of only one of several possible simultaneously formed head chips (e.g., film structures) is illustrated in FIG. 15(1) through FIG. 15(38). Moreover, for further simplification and easy of viewing, FIG. 15(1) through FIG. 15(38) describe formation of only two elements for a head chip, the two elements being on two differing respective planes (e.g., one element per plane). It should be understood how three, four, or more element head chips can be constructed.

The two elements whose formation is described in FIG. 15(1) through FIG. 15(38) happen to be write elements for a write head chip. The write elements each have an inductive write element (e.g., write gap). It should be appreciated that formation of read elements for a read head chip is similarly formed by replacing the coils and poles of the write elements with multi-layer MR read sensors.

Step 15-1, illustrated in FIG. 15(1), show utilization of a non-magnetic wafer material 300, e.g., an Al₂O₃—TiC ceramic (such as Sumitomo AC-7 or Greenleaf GS-2). The wafer thickness as indicated by arrow 301 can be 0.75-2.0 mm (which can be reduced later in the process if desired). A wafer surface 302 is preferably highly polished.

As step 15-2, illustrated in FIG. 15(2), a metallic seed layer 304 comprising 20˜50 nm thick NiFe (Nickel Iron) is sputter deposited onto the wafer surface 302 to ensure good electrical connection and as a bonding aid. As step 15-3, illustrated in FIG. 15(3), a layer 306 of Al₂O₃ (e.g., 3 μm thick) is sputter deposited onto the metallic seed layer of step 15-2.

As step 15-4, illustrated in FIG. 15(4), a Ti (Titanium) seed layer (not shown) (e.g., of 50˜100 nm thickness) is sputter deposited onto the Al₂O₃ surface 306 formed in step 15-3, followed by sputter depositing an additional soft-magnetic layer of CoTaZr (Cobalt Tantalum Zirconium), e.g., 4˜5 μm thick. Using photoresist and etching techniques, these layers are formed into a first plane write bottom pole 310. The seed layer and soft magnetic layer are removed except at the first plane write bottom pole 310, and therefore are not elsewhere illustrated in FIG. 15(4).

As step 15-5, illustrated in FIG. 15(5), two openings 312 are formed in the Al₂O₃ layer 306 of step 15-3 to expose the metallic seed layer 304 of step 15-2. The openings 312 can be formed using photoresist and etching techniques.

As step 15-6, illustrated in FIG. 15(6), another metallic seed layer (not shown) comprising NiFe (e.g., of 20-50 nm thickness), followed by a layer (e.g., ˜100 nm) of Cu (Copper) is deposited over the entire surface. Then, using photoresist and plating techniques, leads 314 and studs 316 (both of ˜2 μm thick Cu) are formed on the metallic seed layer. The studs 316 also make electrical connection, thru the seed layer, to the metallic seed layer 304 of step 15-2. Hereinafter, in the figures layers formed by previous steps are not necessarily shown for easy of illustration and simplification.

As step 15-7, illustrated in FIG. 15(7), using photoresist and plating techniques, additional pads 320 and 322 (e.g., of 2˜4 μm thick Cu) are formed on top of the existing Cu structures, e.g., on leads 314 and studs 316. The metallic seed layer of step 15-6, not underneath the Cu structures, is then removed by sputter etching:

As step 15-8, illustrated in FIG. 15(8), a layer 330 of Al₂O₃ (e.g., ˜5 μm thick) is deposited over the entire surface. Being beneath layer 330, features previously formed are shown in broken line in FIG. 15(8).

As step 15-9, illustrated in FIG. 15(9), using a chemical-mechanical polishing (CMP) process, material is removed (parallel to the original wafer surface) from layer 330 until the thickness of the write bottom pole 310 of step 15-4 is reduced to about 3.5 μm. This also exposes the large and small Cu pads 320, 322 of step 15-7.

As step 15-10, illustrated in FIG. 15(10), a write gap spacer layer 332 (e.g., 0.25 μm thick) of Al₂O₃ is sputter deposited over the bottom write pole 310. The spacer layer 332 is formed to leave a (large) opening 334 for the back gap connection of the magnetic circuit and a (small) opening 336 to keep the small Cu pad 322 clear.

As step 15-11, illustrated in FIG. 15(11), an insulating layer 340 (e.g., ˜1 μm thick) of baked photoresist material is deposited on top of the write gap spacer layer 332 except in a front gap area 342 of the magnetic circuit.

As step 15-12, illustrated in FIG. 15(12), another metallic seed layer (not shown)(e.g., of 20-50 nm Cr (Chromium)) followed by Cu (e.g., ˜100 nm thick) is sputter deposited. Then, using photoresist and plating techniques, a Cu coil 350 (e.g., of ˜2.5 μm thickness) is formed around the opening 334 for the back gap area. FIG. 15(12) only shows four turns of coil 350 for clarity, but the number of turns may differ and preferably is greater, e.g., 12 turns. The ends of the plated write coil are physically and electrically attached (thru the seed layer) to the small Cu pads 322 of step 15-7. Finally, the metallic seed layer is again removed (from everywhere except underneath the plated write coil 350) by sputter etching.

As step 15-13, illustrated in FIG. 15(13), another insulating layer 352 of baked photoresist material is deposited on top of the write coil 350 (e.g., to a distance of 1˜2 μm above the top of the write coil 350). The front gap area 342 and the back gap area 334 of the magnetic circuit are again left clear.

As step 15-14, illustrated in FIG. 15(14), another (unillustrated) NiFe metallic seed layer (e.g., of ˜100 nm thickness) is sputter deposited. Then, using photoresist and plating techniques, an upper write pole 360 of NiFe is formed and plated (e.g., to a thickness of 3˜4 μm). The remaining NiFe seed layer (everywhere except under the write top pole 360) is then removed by etching.

As optional step 15-15, illustrated in FIG. 15(15), using Focused-Ion-Beam (FIB) milling techniques, the front gap area 342 is trimmed (as shown at 362) to the desired width. This removes any mis-alignment between the top write pole 360 and the bottom write pole 310 in the front gap area 342, and can be done to a greater precision than the as-formed shapes of step 15-4 and step 15-14. The FIB areas 362 are shown in FIG. 15(15) as going completely thru both the top write pole thickness and the bottom write pole thickness, but this is not strictly necessary. The FIB areas will pass completely thru the top write pole thickness but may only reach partially into the bottom write pole as long as the depth of the FIB areas extend past the write gap spacer by a distance of −1 μm or more).

As step 15-16, illustrated in FIG. 15(16), another unillustrated metallic seed layer comprising NiFe (e.g., 20-50 nm), followed by Cu (Copper) (e.g., ˜100 nm) is sputter deposited. Then, using photoresist and plating techniques, pairs of studs 370 of Cu (e.g., ˜15 μm thick) are formed on the metallic seed layer on top of the (large) Cu pads 320 formed in step 15-7 (and exposed by the CMP process of step 15-9). Again, the seed layer (everywhere except under the Cu studs 370) is removed by sputter etching.

As step 15-17, illustrated in FIG. 15(17), a layer 372 (e.g., of ˜15 μm thick Al₂O₃) is deposited over the entire surface. Features (un-numbered in FIG. 15(17)) under layer 372 provide layer 372 with a contour similar to the underlying features. Then, as step 15-18, illustrated in FIG. 15(18), using a CMP process, material of layer 372 is removed (parallel to the original wafer surface) to an appropriate distance (e.g., of 15 μm) from the original wafer surface. This produces a flat surface and exposes the Cu studs 370 of step 15-16 while covering all other thin-film structures.

As step 15-19, illustrated in FIG. 15(19), another layer 406 of Al₂O₃ (e.g., 3 μm) is sputter deposited to begin formation of the “second plane” device. As such, the underlying first plane device is not shown in FIG. 15(19). It will be recollected that the device can be either an inductive write gap or an MR head sensor, depending on the type of heat unit being formed.

As step 15-20, illustrated in FIG. 15(20), a Ti seed layer (e.g., of 50˜100 nm thickness) is sputter deposited onto the Al₂O₃ surface of step 15-19, followed by sputter depositing an additional soft-magnetic layer of CoTaZr (e.g., 4˜5 μm thick). Using photoresist and etching techniques, these layers are formed into the second plane write bottom pole 410 (and removed everywhere else in like manner as step 15-4).

As step 15-21, illustrated in FIG. 15(21), using photoresist and etching techniques, six openings 412 in the Al₂O₃ layer 406 of step 15-19 are created to re-expose the Cu studs 370 originally exposed in step 15-18.

As step 15-22, illustrated in FIG. 15(22), another unillustrated metallic seed layer comprising NiFe (e.g., of 20-50 nm thick) followed by a layer of Cu (e.g., ˜100 nm) is deposited over the entire surface. Then, using photoresist and plating techniques, leads 414 and studs 416 of Cu (e.g., ˜2 μm thick) are formed on the metallic seed layer. The studs 416 make electrical connection, thru the seed layer, to the Cu studs 370 exposed in step 15-21.

As step 15-23, illustrated in FIG. 15(23), using photoresist and plating techniques, additional pads 420ₒ, 420₁, 420₂, and 422 of Cu (e.g., 2˜4 μm thick) are formed on top of the existing Cu structures. The pair of pads 420₂ are for the second plane device; the pair of pads 420, connected to the leads 314 of the first plane device; the pair of pads 420₀ connect to wafer ground. The metallic seed layer of step 15-22, not underneath the Cu structures, is then removed by sputter etching.

As step 15-24, illustrated in FIG. 15(24), a layer 430 of Al₂O₃ (e.g., ˜5 μm) is deposited over the entire surface. Being underneath layer 430, features previously formed are shown in broken lines in FIG. 15(24).

As step 15-25, illustrated in FIG. 15(25), using a CMP process, material from layer 430 is removed (parallel to the original wafer surface) until the thickness of the write bottom pole 410 of step 15-20 is reduced (e.g., to approximately 3.5 μm). This also exposes the large and small Cu pads 420, 422, respectively, of step 15-23.

As step 15-26, illustrated in FIG. 15(26), a write gap spacer layer 432 of Al₂O₃ (e.g., 0.25 μm thick) is sputter deposited over the bottom write pole 410. The spacer layer 432 is formed to leave a (large) opening 434 for the back gap connection of the magnetic circuit and a (small) opening 436 to keep the small Cu pad 422 clear.

As step 15-27, illustrated in FIG. 15(27), an insulating layer 440 (e.g., ˜1 μm thick) of baked photoresist material is deposited on top of the write gap spacer 434 except for in a front gap area 442 of the magnetic circuit.

As step 15-28, illustrated in FIG. 15(28), another unillustrated metallic seed layer of Cr (Chromium)(e.g., 20-50 nm thick), followed by a layer of Cu (e.g., ˜100 nm) is sputter deposited. Then, using photoresist and plating techniques, another Cu coil 450 (e.g., ˜2.5 μm thickness) is formed around the opening 434 for the back gap area. The ends of the plated write coil 450 are physically and electrically attached (thru the seed layer) to the small Cu pads 422 of step 15-23. Finally, the metallic seed layer is again removed (from everywhere except underneath the plated write coil 450) by sputter etching.

As step 15-29, illustrated in FIG. 15(29), another insulating layer 452 of baked photoresist material is deposited on top of the write coil 450 (e.g., to a distance of 1˜2 μm above the top of the write coil). The front gap area 442 and the back gap area 434 of the magnetic circuit are again left clear.

As step 15-30, illustrated in FIG. 15(30), another unillustrated NiFe metallic seed layer (e.g., of ˜100 nm thickness) is sputter deposited. Then, using photoresist and plating techniques, an upper write pole 470 of NiFe is formed and plated (e.g., to a thickness of 3˜4 μm). The remaining NiFe seed layer (everywhere except under the write top pole 470) is then removed by sputter etching.

As optional step 15-31, illustrated in FIG. 15(31), in like manner as step 15-15, Focused-Ion-Beam (FIB) milling techniques can be employed. The front gap area 442 is trimmed at points 462 to the desired width.

As step 15-32, illustrated in FIG. 15(32), another unillustrated metallic seed layer comprising NiFe (e.g., of 20-50 nm thickness), followed by a layer of Cu (Copper)(e.g., ˜100 nm) is sputter deposited. Then, using photoresist and plating techniques, pairs of studs 470₂, 470₁, 470_{O} are formed of Cu (e.g., ˜20 μm thick) on the metallic seed layer on top of the (large) Cu pads 420 formed in step 15-23 (and exposed by the CMP process of step 15-25). Again, the seed layer (everywhere but under the Cu studs 470) is removed by sputter etching.

As step 15-33, illustrated in FIG. 15(33), a layer 472 of Al₂O₃ (e.g., ˜20 μm thick) is deposited over the entire surface. Then, as step 15-34, illustrated in FIG. 15(34), using a CMP process, material of layer 472 is removed (parallel to the original wafer surface) to a distance (e.g., 35 μm) from the original wafer surface. This produces a flat surface and exposes the Cu studs 470₂, 470₁, 470_{O} of step 15-32 (while covering all other thin-film structures.

As step 15-35, illustrated in FIG. 15(35), using photoresist and etching techniques, recessed areas 480 (˜3 μm deep) are made in the flat surface produced in step 15-34. Then, as step 15-36, illustrated in FIG. 15(36), another metallic seed layer 482 comprising NiFe (e.g., ˜100 nm thick) is sputter deposited over the entire surface formed in step 15-35. Then, using photoresist and plating techniques, Au (Gold) contact pads 484_{X}, 484₀, 484₁, 484₂ are formed on the metallic seed layer 482. The contact pads 484 also make electrical connection, thru the seed layer 482, to the Cu studs 470₂, 470₁, 470₀ of step 15-32 exposed in step 15-34.

As step 15-37, illustrated in FIG. 15(37), using photoresist and etching techniques, part of the seed layer 482 from step 15-35 is removed to separate the five leftmost contact pads 484₂, 484_{X}, 484₁ from each other, but part 485 of the seed layer from step 15-35 is left in place remaining in electrical contact with the first contact pad 484_{O} in order to make electrical contact with the cover chip 486 (from cover bar 214 [see step 14(3) through 14(4)]).

As step 15-38, illustrated in FIG. 15(38), the cover chip 486 is bonded in place using adhesive 242 deposited in the recesses 480 of step 15-35 such that the cover chip 486 makes electrical contact with the (partial) seed layer 485 of step 15-37 (and consequently with the first contact pad 484₀). The first plane device D₁ (formed by poles 310 and 360 and coil 350 therebetween) and the second plane device D₂ (formed by poles 410 and 460 and coil 450 therebetween) are illustrated in FIG. 15(38).

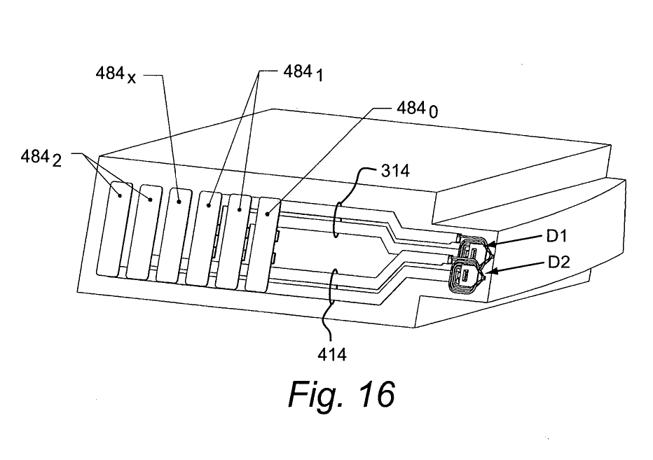

As a result of performance of step 15-1 through step 15-38, a monolithic, multi-device head chip is formed. The devices D₁ and D₂ are on differing planes. FIG. 16 illustrates the electrical connections and magnetic poles of the head chip (where all non-conducting and non-magnetic layers are shown as transparent).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A head unit for use in a helical scan magnetic tape drive, the head unit comprising:
a substrate having a substrate surface;
multiple thin film magnetic elements formed on the substrate, each element having an interactive component for transducing information with respect to magnetic tape, the interactive components of at least two elements being situated on different planes at respective different distances from the substrate surface;
wherein none of the multiple elements of the head unit are situated to traverse a same path; and
wherein all of the multiple elements of the head unit perform a same type of transducing operation.

2. The apparatus of claim 1, wherein the same transducing operation is a write operation, and wherein the interactive component is a front gap of a write element.

3. The apparatus of claim 1, wherein the same transducing operation is a read operation, and wherein the interactive component is a MR layer of a read element.

4. The apparatus of claim 1, wherein the head unit comprises three thin film magnetic elements having their respective interactive components on three planes, the three planes being at three differing distances from the substrate surface.

5. The apparatus of claim 1, further comprising a cover bar, and wherein the multiple thin film magnetic elements are located between the substrate and the cover bar.

6. The apparatus of claim 1, wherein the head unit comprises M*N thin film magnetic elements having their respective interactive components on N number of planes, the N number of planes being a N number of differing distances from the substrate surface, N being an integer greater than one, M being an integer greater than zero.

7. A scanner for a helical scan tape drive, the scanner comprising:
a rotatable drum;
at least two write head units mounted at the periphery of the drum;
at least two read head units mounted at the periphery of the drum;
at least one of the head units comprising:
a substrate having a substrate surface;
multiple thin film magnetic elements formed on the substrate, each element having an interactive component for transducing information with respect to magnetic tape, the interactive components of at least two elements being situated on different planes at respective different distances from the substrate surface;
wherein none of the multiple elements of the head unit are situated to traverse a same path on the magnetic tape; and
wherein all of the multiple elements of the head unit perform a same type of transducing operation.

8. The apparatus of claim 7, wherein the same transducing operation is a write operation, and wherein the interactive component is a front gap of a write element.

9. The apparatus of claim 7, wherein the same transducing operation is a read operation, and wherein the interactive component is a MR layer of a read element.

10. The apparatus of claim 7, wherein the head unit comprises three thin film magnetic elements having their respective interactive components on three planes, the three planes being at three differing distances from the substrate surface.

11. The apparatus of claim 7, further comprising a cover bar, and wherein the multiple thin film magnetic elements are located between the substrate and the cover bar.

12. The apparatus of claim 7, wherein the head unit comprises M*N thin film magnetic elements having their respective interactive components on N number of planes, the N number of planes being a N number of differing distances from the substrate surface, N being an integer greater than one, M being an integer greater than zero.

13. The apparatus of claim 7, wherein there are two write head units, each write head unit having two interactive components formed on two respective differing planes.

14. The apparatus of claim 7, wherein there are two write head units, each write head unit having four interactive components formed on four respective differing planes.

15. The apparatus of claim 7, wherein there are two write head units, each write head unit having four interactive components formed on two respective differing planes, each plane having two interactive components.

16. The apparatus of claim 7, wherein two write head units are situated 180 degrees apart about the periphery of the drum, and wherein two read had units are situated 180 degrees apart about the periphery of the drum.

17. The apparatus of claim 7, wherein at least two write head units have interactive components of differing azimuthal angles and at least two read head units have interactive components of differing azimuthal angles.

18. A method of making a head unit for a helical scan tape drive, the method comprising:
forming a first thin film magnetic element on a substrate, the first thin film element having an interactive component for transducing information with respect to magnetic tape, the interactive component for the first thin film magnetic element being situation on a first plane at a first distance from a surface of the substrate;
forming a second thin film magnetic element on a substrate, the second thin film element having an interactive component for transducing information with respect to magnetic tape, the interactive component for the second thin film magnetic element being situation on a second plane at a second distance from a surface of the substrate, the second distance not being equal to the first distance;
situating the first thin film magnetic element and the second thin film magnetic element to traverse different paths;
forming the first thin film magnetic element and the second thin film magnetic element to perform a same type of transducing operation.

19. The method of claim 18, wherein the same transducing operation is a write operation, and wherein the interactive component is a front gap of a write element.

20. The method of claim 18, wherein the same transducing operation is a read operation, and wherein the interactive component is a MR layer of a read element.

21. The method of claim 18, further comprising forming a third thin film magnetic elements having its respective interactive component on a third planes, the third planes being at a third distance from the substrate, the third distance not being equal to the first distance or the second distance.

22. The method of claim 18, further comprising situating the multiple thin film magnetic elements between the substrate and a cover bar.

23. The method of claim 18, further comprising forming M*N number of thin film magnetic elements having their respective interactive components on N number of planes, the N number of planes being a N number of differing distances from the substrate surface, N being an integer greater than one, M being an integer greater than zero.
